(19) United States
(12) Patent Application Publication
(10) Pub. No.: US 2026/0160716 A1
(43) Pub. Date: Jun. 11, 2026

(54) PHYSICAL-PROPERTY ESTIMATION APPARATUS, PHYSICAL-PROPERTY ESTIMATION SYSTEM, PHYSICAL-PROPERTY ESTIMATION METHOD, AND STORAGE MEDIUM

(71) Applicant: CANON KABUSHIKI KAISHA, Tokyo (JP)

(72) Inventor: TAKAMITSU HOSHIHIRA, Kanagawa (JP)

(21) Appl. No.: 19/406,107

(22) Filed: Dec. 2, 2025

(30) Foreign Application Priority Data
Dec. 5, 2024 (JP) 2024-212269
Oct. 24, 2025 (JP) 2025-179582

(51) Int. Cl. G01N 23/2251

(52) U.S. Cl. CPC G01N 23/2251; G01N 2223/401; G01N 2223/418

(57) ABSTRACT

A physical-property estimation apparatus includes a processor. The processor is configured to accept a first image obtained by capturing an image of a first image-capture range of a sample with a first magnification, a first physical-property value of a first range of the sample, and a second image obtained by capturing an image of a second image-capture range of the sample larger than the first image-capture range, with a second magnification lower than the first magnification, and estimate a second physical-property value of a second range of the sample larger than the first range, by using at least the first image, the first physical-property value, and the second image.

### BACKGROUND

### Field of the Technology

The present disclosure relates to a physical-property estimation apparatus, a physical-property estimation system, a physical-property estimation method, and a storage medium.

### Description of the Related Art

In the material development, raw materials to be used are selected, the amount of each raw material to be mixed is determined, and a sample is produced by using various processes, such as agitation, kneading, and heating. In addition, physical-property values of physical properties of the sample are obtained for evaluating the sample produced as described above. A material that satisfies desired physical-property values is found out by controlling the microscopic structure, such as the composition of the material, the phase, and the distribution of mixed filler, through the mixing of the raw materials and the production process. In such material development, data-driven material development is performed, and it is reported that an apparatus estimates a physical-property value of a material by using the machine learning, based on the information on the material structure, such as a spectrum, an image, or a graph of the material.

By the way, there is a case where a physical-property value obtained in a microscopic area and a physical-property value obtained in a macroscopic area are different from each other. In addition, there is a case where a physical property can be measured in a microscopic area but is difficult to be measured in a macroscopic area.

Japanese Patent Application Publication No. 2023-7163 discloses an apparatus that estimates a value of ductility of a steel material by using an estimation model created in the machine learning. The estimation model is created by using, as input, feature values extracted from a plurality of images of the steel material captured with different magnifications.

However, in the method described in Japanese Patent Application Publication No. 2023-7163, it is necessary for an image to contain the microscopic material-structure information that produces the physical property. Thus, in a case where the method is applied to another sample, the accuracy for estimating the physical property is not necessarily sufficient.

### SUMMARY

The present disclosure provides a technology advantageous for increasing the accuracy for estimating the physical-property value of a sample.

According to a first aspect of the present disclosure, a physical-property estimation apparatus includes a processor. The processor is configured to accept a first image obtained by capturing an image of a first image-capture range of a sample with a first magnification, a first physical-property value of a first range of the sample, and a second image obtained by capturing an image of a second image-capture range of the sample larger than the first image-capture range, with a second magnification lower than the first magnification, and estimate a second physical-property value of a second range of the sample larger than the first range, by using at least the first image, the first physical-property value, and the second image.

According to a second aspect of the present disclosure, a physical-property estimation method performed by a processor, the method including accepting, by the processor, a first image obtained by capturing an image of a first image-capture range of a sample with a first magnification, a first physical-property value of a first range of the sample, and a second image obtained by capturing an image of a second image-capture range of the sample larger than the first image-capture range, with a second magnification lower than the first magnification, and estimating, by the processor, a second physical-property value of a second range of the sample larger than the first range, based on the first image, the first physical-property value, and the second image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of a physical-property estimation system of a first embodiment.

FIG. 2A is a functional block diagram of a CPU of a physical-property estimation apparatus of the first embodiment.

FIG. 2B is a diagram illustrating one example of learning data of the first embodiment.

FIG. 2C is a diagram illustrating one example of input data that is used for the inference in the first embodiment, and of output data that is an inference result.

FIG. 3A is a schematic diagram of a small test piece of the first embodiment.

FIG. 3B is a schematic diagram of an image obtained by capturing an image of an image capture range of the test piece of the first embodiment.

FIG. 4A is a schematic diagram of a standard test piece of the first embodiment.

FIG. 4B is a schematic diagram of an image obtained by capturing an image of an image capture range of the standard test piece of the first embodiment.

FIG. 5 is a diagram illustrating the machine learning performed in the first embodiment.

FIG. 6A is a schematic diagram of a sample of the first embodiment.

FIG. 6B is a schematic diagram of a first image obtained by capturing an image of a first image-capture range of the sample of the first embodiment.

FIG. 6C is a schematic diagram of a second image obtained by capturing an image of a second image-capture range of the sample of the first embodiment.

FIG. 7A is a diagram illustrating one example of learning data of a second embodiment.

FIG. 7B is a diagram illustrating one example of input data that is used for the inference in the second embodiment, and of output data that is an inference result.

FIG. 8A is a schematic diagram of a small test piece of the second embodiment.

FIG. 8B is a schematic diagram of an image capture range of the small test piece of the second embodiment, and of an image obtained by capturing an image of the image capture range.

FIG. 8C is a schematic diagram of an image capture range of the small test piece of the second embodiment, and of an image obtained by capturing an image of the image capture range.

FIG. 9A is a schematic diagram of a standard test piece of the second embodiment.

FIG. 9B is a schematic diagram of an image obtained by capturing an image of an image capture range of the standard test piece of the second embodiment.

FIG. 10 is a diagram illustrating the machine learning in the second embodiment.

FIG. 11A is a schematic diagram of a sample of the second embodiment.

FIG. 11B is a schematic diagram of a first image obtained by capturing an image of a first image-capture range of the sample of the second embodiment.

FIG. 11C is a schematic diagram of a third image obtained by capturing an image of a third image-capture range of the sample of the second embodiment.

FIG. 11D is a schematic diagram of a second image obtained by capturing an image of a second image-capture range of the sample of the second embodiment.

FIG. 12A is a diagram illustrating one example of learning data of a third embodiment.

FIG. 12B is a diagram illustrating one example of input data that is used for the inference in the third embodiment, and of output data that is an inference result.

FIG. 13A is a schematic diagram of a small test piece of the third embodiment.

FIG. 13B is a schematic diagram of an image obtained by capturing an image of an image capture range of the small test piece of the third embodiment.

FIG. 14A is a schematic diagram of a standard test piece of the third embodiment.

FIG. 14B is a schematic diagram of an image obtained by capturing an image of an image capture range of the standard test piece of the third embodiment.

FIG. 15 is a diagram illustrating the machine learning in the third embodiment.

FIG. 16A is a schematic diagram of a sample of the third embodiment.

FIG. 16B is a schematic diagram of a first image obtained by capturing an image of a first image-capture range of the sample of the third embodiment.

FIG. 16C is a schematic diagram of a second image obtained by capturing an image of a second image-capture range of the sample of the third embodiment.

FIG. 17A is a diagram illustrating one example of learning data of a fourth embodiment.

FIG. 17B is a diagram illustrating one example of input data that is used for the inference in the fourth embodiment, and of output data that is an inference result.

FIG. 18 is a diagram illustrating the machine learning in the fourth embodiment.

### DESCRIPTION OF THE EMBODIMENTS

Hereafter, the following embodiments will be described with reference to the accompanying drawings. Note that since each of the following embodiments is one example, the configuration of a detail or the like of the present disclosure can be modified by a person skilled in the art, without departing the spirit of the present disclosure.

### First Embodiment

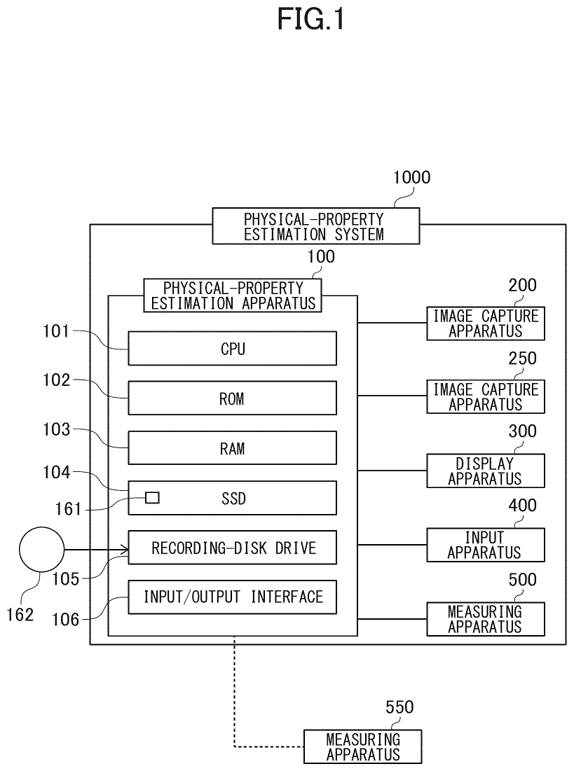

FIG. 1 is a diagram illustrating a schematic configuration of a physical-property estimation system 1000 of a first embodiment. The physical-property estimation system 1000 includes a physical-property estimation apparatus 100, an image capture apparatus 200, an image capture apparatus 250, a display apparatus 300, an input apparatus 400, and a measuring apparatus 500. The physical-property estimation apparatus 100 includes one or more computers. In the following description, the physical-property estimation apparatus 100 includes a single computer, for example.

The physical-property estimation apparatus 100 is one example of an information processing apparatus. The physical-property estimation apparatus 100 is connected with the image capture apparatus 200, the image capture apparatus 250, the display apparatus 300, the input apparatus 400, and the measuring apparatus 500. Note that although a measuring apparatus 550 can be connected to the physical-property estimation apparatus 100, the measuring apparatus 550 is used in a below-described learning phase of the physical-property estimation apparatus 100 and is not used in an estimation phase.

The image capture apparatus 200 is one example of a first image-capture apparatus. The image capture apparatus 200 may be a microscope, an optical microscope, a scanning electron microscope (SEM), a transmission electron microscope (TEM), or a computed tomography (X-ray CT). In the first embodiment, the description will be made for a case where the image capture apparatus 200 is a microscope.

The image capture apparatus 250 is one example of a second image-capture apparatus. The image capture apparatus 250 may be an optical microscope, a SEM, or an X-ray CT. Hereinafter, the description will be made for a case where the image capture apparatus 250 is an optical microscope. The image capture apparatus 200 and the image capture apparatus 250 are used for capturing images of subjects. The image capture apparatus 200 can capture an image of a subject with a magnification higher than that of the image capture apparatus 250.

The display apparatus 300 is a display, for example. The input apparatus 400 is a keyboard or a mouse, for example. The measuring apparatus 500 is, for example, a scanning probe microscope (SPM), and can be used for measuring the electrical resistance, as a physical property, of a microscopic area. The measuring apparatus 550 can be used for measuring the electrical resistance, as a physical property, of a macroscopic area larger than the area measured by the measuring apparatus 500.

The physical-property estimation apparatus 100 may be any computer, such as a desktop computer, a tablet computer, or a laptop computer. In addition, the physical-property estimation apparatus 100 may be a general-purpose computer or a special-purpose computer. In addition, the physical-property estimation apparatus 100 may be a computer in which the display apparatus 300 and the input apparatus 400 are integrated with a computer body. In addition, the display apparatus 300 and the input apparatus 400 may constitute a touch-panel display that has both of the display function and the input function.

The physical-property estimation apparatus 100 includes a central processing unit (CPU) 101, which is one example of a processor. The CPU 101 is an information processing portion. The physical-property estimation apparatus 100 also includes, as storage portions, a read only memory (ROM) 102, a random access memory (RAM) 103, and a solid state drive (SSD) 104. In addition, the physical-property estimation apparatus 100 includes a recording-disk drive 105 and an input/output interface 106. The CPU 101, the ROM 102, the RAM 103, the SSD 104, the recording-disk drive 105, and the input/output interface 106 are connected with each other via a bus such that data can be transmitted from one to another. The image capture apparatus 200, the image capture apparatus 250, the display apparatus 300, the input apparatus 400, and the measuring apparatus 500 are connected to the input/output interface 106.

The ROM 102 stores a basic program related to the operation of the computer. The RAM 103 is a storage device that temporarily stores various types of data, such as results of computation performed by the CPU 101. The SSD 104 stores results of computation performed by the CPU 101 and various types of data obtained from the outside, and stores a program 161 that causes the CPU 101 to perform various types of processing. The program 161 includes an application software program that can be executed by the CPU 101.

The CPU 101 executes a below-described information processing by executing the program 161 stored in the SSD 104. The recording-disk drive 105 can read various types of data and programs stored in a recording disk 162. The recording-disk drive 105 can read data stored in the recording disk 162, which is one example of a storage medium. The CPU 101 accepts information input by a user via the input apparatus 400.

Note that in the first embodiment, the SSD 104 is a non-transitory computer-readable storage medium, and stores the program 161. However, the present disclosure is not limited to this. The program 161 may be stored in any storage medium as long as the storage medium is a non-transitory computer-readable storage medium. The storage medium that supplies the program 161 to the computer may be a flexible disk, a hard disk, an optical disk, a magneto-optical disk, a magnetic tape, a nonvolatile memory, or the like. The nonvolatile memory is a USB memory or an SD card, for example. The program 161 may be obtained from a network (not illustrated).

The physical-property estimation apparatus 100 may be a component other than the above-described components. For example, the physical-property estimation apparatus 100 may be a programmable logic device (PLD), such as a field programmable gate array (FPGA), an application specific integrated circuit (ASIC), a general-purpose or special-purpose computer in which the program is embedded, or a component in which part or all of the above-described components are combined with each other.

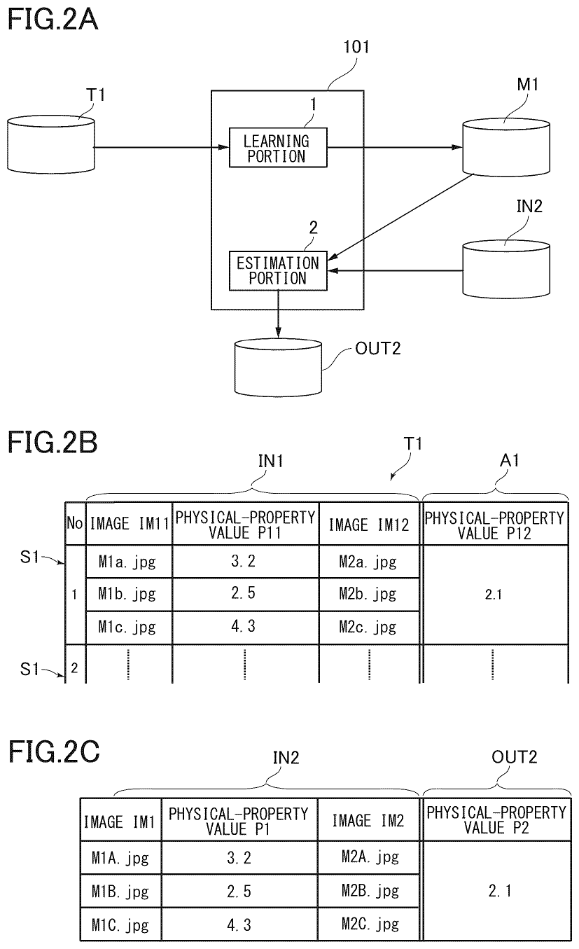

FIG. 2A is a functional block diagram of the CPU 101 of the physical-property estimation apparatus 100 of the first embodiment. In the first embodiment, the CPU 101 functions as a learning portion 1 and an estimation portion 2 by executing the program 161. Specifically, the CPU 101 functions as the learning portion 1 in a learning phase, and as the estimation portion 2 in an inference phase. The learning portion 1 executes a learning method, and the estimation portion 2 executes a physical-property estimation method. In the following description, an object on which the inference is performed is expressed as a sample, and an object which is used for obtaining the learning data is expressed as a test piece. For example, the sample is a prototype.

Note that in the first embodiment, the description will be made for a case where the function of the learning portion 1 and the function of the estimation portion 2 are achieved by a single computer. However, the present disclosure is not limited to this. For example, the function of the learning portion 1 and the function of the estimation portion 2 may be achieved by a plurality of computers. For example, the function of the learning portion 1 (i.e., machine learning) may be achieved by another computer other than the physical-property estimation apparatus 100, and the function of the estimation portion 2 may be achieved by the physical-property estimation apparatus 100. In this case, the physical-property estimation apparatus 100 may obtain the learned machine-learning model from the other computer.

The learning portion 1 performs the supervised learning in the learning phase, as the machine learning. The learning portion 1 performs the supervised machine learning by using learning data T1, and creates a learned machine-learning model M1. The learning data T1 includes a plurality of data sets S1, each of which includes input data IN1 and correct answer data A1. The machine-learning model M1 is stored, for example, in the SSD 104 illustrated in FIG. 1. The estimation portion 2 performs the inference on input data IN2 in the inference phase, by using the learned machine-learning model M1; and outputs output data OUT2 that is an inference result. Note that in the following description, the meaning of the estimation and the meaning of the inference are the same as each other.

FIG. 2B is a diagram illustrating one example of the learning data T1 of the first embodiment. Each of the plurality of data sets S1 includes, as the input data IN1, at least one image IM11 of a microscopic area of a test piece, at least one physical-property value P11 of a physical property of a microscopic area of the test piece, and at least one image IM12 of a macroscopic area of a test piece. In addition, each of the plurality of data sets S1 includes, as the correct answer data A1, a physical-property value P12 of a physical property of a macroscopic area of a test piece. Note that the physical property is a property, such as a mechanical property, an electrical property, a thermal property, a magnetic property, or an optical property. The physical-property value is a value of the property. For example, in a case where the electrical property is the electrical resistance, the physical-property value is an electrical resistance value (Ω).

The image IM11 is digital data, such as a captured image, obtained by the image capture apparatus 200 capturing an image of a test piece with a first magnification. The image IM12 is digital data, such as a captured image, obtained by the image capture apparatus 250 capturing an image of a test piece with a second magnification lower than the first magnification. The image capture apparatus 200 captures an image of a test piece with a magnification higher than that of the image capture apparatus 250. Both of the image IM11 and the image IM12 are images captured with magnifications higher than 1.

FIG. 2C is a diagram illustrating one example of the input data IN2 that is used for the inference in the first embodiment, and of output data OUT2 that is an inference result. The input data IN2 includes at least one image IM1 of a microscopic area of a sample, at least one physical-property value P1 of a physical property of a microscopic area of the sample, and at least one image IM2 of a macroscopic area of the sample. The output data OUT2 is a physical-property value P2 of a physical property of a macroscopic area of the sample.

The image IM1 is digital data, such as a captured image, obtained by the image capture apparatus 200 capturing an image of the sample with a first magnification. The image IM2 is digital data, such as a captured image, obtained by the image capture apparatus 250 capturing an image of the sample with a second magnification. The image capture apparatus 200 captures an image of the sample with a magnification higher than that of the image capture apparatus 250. Both of the image IM1 and the image IM2 are images captured with magnifications higher than 1.

The number of the images IM1 is the same as the number of the images IM11 of a single data set S1. The number of the physical-property values P1 is the same as the number of the physical-property values P11 of a single data set S1. The number of the images IM2 is the same as the number of the images IM12 of a single data set S1.

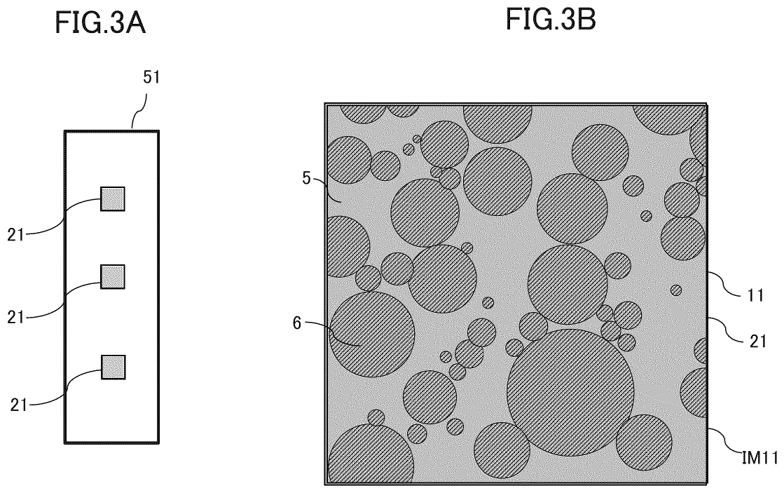

FIG. 3A is a schematic diagram of a small test piece 51 of the first embodiment. FIG. 3B is a schematic diagram of the image IM11 obtained by capturing an image of an image capture range 21 of the small test piece 51 of the first embodiment. In the first embodiment, each of the test piece used for the learning and the sample used for the inference is a composite member produced by dispersing metal fillers 6 having a predetermined particle-diameter distribution, in a thermosetting resin material 5 at a predetermined ratio and by thermally curing the thermosetting resin material 5. The estimation portion 2 estimates the electrical resistance value of the sample, as the physical-property value of a physical property of the sample. For example, each of the metal fillers 6 is a silver (Ag) particle or a copper (Cu) particle having a diameter of 0.1 to 10 μm. Note that examples of the physical-property value of the physical property estimated by the physical-property estimation apparatus 100 include, in addition to the electrical resistance value, the value of electric conductivity, the value of thermal conductivity, the value of thermal diffusivity, and the value of modulus of elasticity. In addition, each of the test piece and the sample may be made of not resin but metal, ceramic, or rubber. In another case, each of the test piece and the sample may be a composite member in which any one of the above-described materials contains filler made of carbon, metal, oxide, or nitride.

Hereinafter, a method of obtaining the learning data T1 used for the machine learning will be described. The small test piece 51 illustrated in FIG. 3A is made by cutting the composite member formed like a sheet, into thin pieces by using a microtome. In size, the small test piece 51 has an area of 1 mm×0.3 mm, and a thickness of 1 μm.

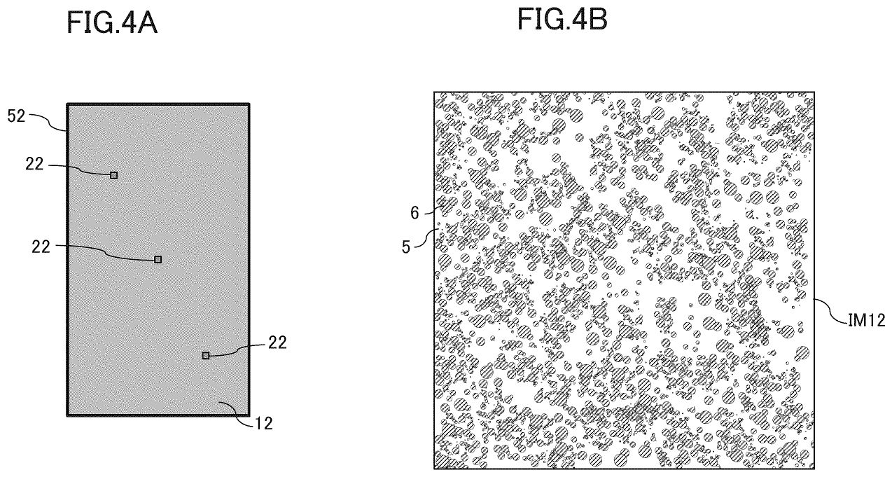

FIG. 4A is a schematic diagram of a standard test piece 52 of the first embodiment. FIG. 4B is a schematic diagram of the image IM12 obtained by capturing an image of an image capture range 22 of the standard test piece 52 of the first embodiment. Note that the small test piece 51 illustrated in FIG. 3A and the standard test piece 52 illustrated in FIG. 4A may be the same test piece, or may be different test pieces made by using the same material and method and substantially equal to each other in quality. In the present embodiment, the standard test piece 52 is made of substantially the same material as that of the small test piece 51; and in size, has an area of 100 mm×50 mm and a thickness of 1 mm.

The image IM11 illustrated in FIG. 3B is an image of any one of a plurality of (e.g., three) image capture ranges 21 of the small test piece 51 illustrated in FIG. 3A, captured with a magnification of 500 that is a first magnification, by using a microscope that is one example of the image capture apparatus 200.

For example, each of the image capture ranges 21 of the small test piece 51 has a size of 100 μm×100 μm. For reducing the variations in physical property of portions of the small test piece 51 that occur depending on the positions of the portions, images of three image capture ranges 21 are captured by using the image capture apparatus 200, so that a plurality of (e.g., three) images IM11 are obtained. Note that instead of the microscope, the images of the image capture ranges 21 may be captured by using an optical microscope, a scanning electron microscope (SEM), a transmission electron microscope (TEM), or an X-ray CT.

The magnification for capturing images may be set freely in accordance with the material, in consideration of the structure of the material that produces the physical property of the material. Specifically, the structure of the material involves the microscopic structure of the material, the phase, and the distribution of mixed filler. For example, the magnification for capturing images may be about 500 to 5000. In addition, before images of the small test piece 51 are captured, polishing, etching, or plasma treatment may be performed on the small test piece 51. In addition, the surface of the small test piece 51 may be covered with a thin electrically-conductive film, which is generally formed on an observation surface of an insulator material in a case where the insulator material is observed by using an SEM.

The image IM12 illustrated in FIG. 4B is an image of any one of a plurality of (e.g., three) image capture ranges 22 of the standard test piece 52 illustrated in FIG. 4A, captured with a magnification of 50 that is a second magnification lower than the first magnification, by using an optical microscope that is one example of the image capture apparatus 250.

For example, each of the image capture ranges 22 of the standard test piece 52 has a size of 1 mm×1 mm. For reducing the variations in physical property of portions of the standard test piece 52 that occur depending on the positions of the portions, images of a plurality of (e.g., three) image capture ranges 22 are captured by using the image capture apparatus 250, so that the plurality of images IM12 are obtained. Note that instead of the optical microscope, the images of the image capture ranges 22 may be captured by using, for example, an SEM or an X-ray CT. In addition, the image IM12 may be captured by using the same image capture apparatus and under the same condition as those for the image IM11. That is, the image IM11 and the image IM12 may be captured by using the same image capture apparatus.

The first magnification may be equal to or higher than 5 times the second magnification and equal to or lower than 20 times the second magnification. This is because less information is obtained if the second magnification is too close to the first magnification, and because the accuracy for estimating the physical property deteriorates if the second magnification is set too low. In the case where the second magnification is set too low, the accuracy deteriorates because it becomes difficult to obtain the distribution in the structure and the arrangement of the filler.

Then, in a range 11 of the small test piece 51 related to the image IM11 obtained by capturing an image of the image capture range 21, the physical-property value P11 of a physical property is measured by using the measuring apparatus 500. In the first embodiment, the electrical property (i.e., electrical resistance) of the range 11 of the small test piece 51 is measured, as the physical property of the small test piece 51, by using a scanning probe microscope (SPM) that serves as the measuring apparatus 500, and thereby the electrical resistance value is obtained as the physical-property value P11 of the range 11. Specifically, the current image distribution of the range 11 of the small test piece 51 is determined by using the SPM, then the resistance distribution of the range 11 is determined from the current image distribution of the range 11, and then the resistance distribution of the range 11 is averaged, so that the electrical resistance value of the range 11 is obtained as the physical-property value P11.

The range 11 overlaps with the image capture range 21. Specifically, part or all of the range 11 overlaps with part or all of the image capture range 21. In the examples illustrated in FIGS. 3A and 3B, both of the range 11 and the image capture range 21 have the same rectangular shape and the same size. The range 11 and the image capture range 21 slightly deviate from each other, and part of the range 11 overlaps with part of the image capture range 21. In the first embodiment, since a plurality of (e.g., three) image capture ranges 21 are set in the small test piece 51, ranges 11 that are measurement ranges of a physical property are set correspondingly for the plurality of (e.g., three) image capture ranges 21. Thus, the physical property is measured for each of the plurality of (e.g., three) ranges 11, so that the plurality of (e.g., three) physical-property values P11 are obtained.

The range 11 corresponds to a range of magnification from the first magnification to the second magnification. That is, the range 11 may be equal to or larger than the image capture range 21, and equal to or smaller than the image capture range 22.

In another case, the range 11 may be substantially equal to the image capture range 21. That is, the range 11 may be equal to or larger than 0.9 times the image capture range 21 and equal to or smaller than 1.1 times the image capture range 21.

In the first embodiment, an image of the image capture range 21 of the small test piece 51 is captured by using a microscope that belongs to an SPM, and an electrical resistance value is obtained from a current image distribution obtained in the same portion of the small test piece 51. Thus, the range 11 is substantially equal to the image capture range 21.

The position of the image capture range 21 and the range 11 may be determined by using a microscope that belongs to the measuring apparatus 500, or the image capture apparatus 200 that may be a microscope. In another case, the position of the image capture range 21 and the range 11 may be determined by using a mark (e.g., marking) formed in advance in the small test piece 51.

In the first embodiment, the physical-property value P12, which is the correct answer data A1 of the learning data T1, is obtained by using the measuring apparatus 550 different from the measuring apparatus 500. The physical-property value P12 is obtained by measuring a range 12 of the standard test piece 52 by using the measuring apparatus 550. The range 12 is a range larger than the range 11. In the present embodiment, the physical-property value P12 is an electrical resistance value of the electrical resistance of the range 12 of the standard test piece 52.

The measuring apparatus 550 includes two electrodes attached to both ends of the standard test piece 52 in the longitudinal direction, a voltage source that applies a predetermined voltage between the two electrodes, and an ammeter that measures the current that flows between the two electrodes to which the predetermined voltage is applied from the voltage source. The electrical resistance value that is a value of the electrical resistance of the range 12 of the standard test piece 52 is obtained from the current value measured by the ammeter. In the first embodiment, the range 12 of the standard test piece 52 is the whole of the standard test piece 52.

In a case where the range 12 is significantly larger than the range 11 as in the first embodiment, it is generally difficult to measure the physical properties of the range 11 and the range 12 by using the same measuring apparatus 500. Thus, the same type of physical property (i.e., electrical resistance) is measured for the range 11 and the range 12 by using different methods by using the different measuring apparatuses 500 and 550.

In the learning phase, the images IM11 and IM12 and the physical-property values P11 and P12 are obtained from a plurality of small test pieces 51 and a plurality of standard test pieces 52, which have different compositions of a material, the different amounts of mixed filler, and different processes for producing the material that involve a mixing condition and a heat-treatment condition. Thus, a plurality of data sets S1 is created, and constitutes the learning data T1. In this case, each of the plurality of data sets S1 includes the image IM11, the physical-property value P11, and the image IM12, as the input data IN1; and includes the physical-property value P12, as the correct answer data A1.

Note that in a single data set S1, the input data IN1 may include a single image IM11, a single physical-property value P11, and a single image IM12. However, the single data set S1 may include a plurality of (e.g., three) images IM11, a plurality of (e.g., three) physical-property values P11, and a plurality of (e.g., three) images IM12. For reducing the variations of a material as described above, a plurality of (e.g., three) images IM11 and a plurality of (e.g., three) physical-property values P11 are obtained from a single small test piece 51, and a plurality of (e.g., three) images IM12 are obtained from a single standard test piece 52. The plurality of images IM11, the plurality of physical-property values P11, and the plurality of images IM12 constitute the input data IN1 of a single data set S1. The supervised machine learning is performed on the input data IN1 by using the physical-property value P12, measured in the range 12, as the correct answer data A1, so that the machine-learning model M1 used for estimating a physical-property value is obtained.

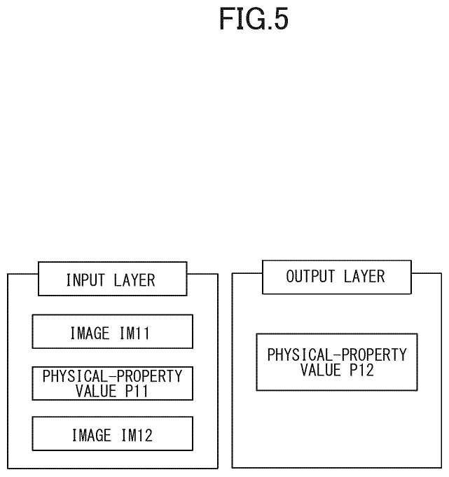

Next, a specific example of the learning method of the learning portion 1 will be described. For example, in the machine learning performed by the learning portion 1, a regression model that uses the convolutional neural network (CNN) is used. FIG. 5 is a diagram illustrating the machine learning performed in the first embodiment. FIG. 5 illustrates an input layer and an output layer of a regression model that uses the CNN. The input layer includes three images IM11, three physical-property values P11, and three images IM12. The learning portion 1 performs the machine learning so that a single physical-property value P12 is output via a plurality of intermediate layers, so that the learned machine-learning model M1 that is an estimation model is created. Note that the method of the machine learning is not limited to the CNN. In addition, the number of the data sets S1 may be equal to or larger than 50 for increasing the accuracy for estimating the physical property. For example, the number of the data sets S1 may be equal to or larger than 100.

Such information is input to the learning portion 1, and thereby the learning portion 1 performs the machine learning. As a result, also for a case where the distribution in physical property of a microscopic area of a material contributes to the physical property of a macroscopic area larger than the microscopic area, the machine-learning model M1 that can estimate the physical property of the macroscopic area with high accuracy is created.

Note that although the description has been made for the case where the physical property measured in each of the range 11 and the range 12 is the electrical property, the present disclosure is not limited to this. For example, the physical property measured in each of the range 11 and the range 12 may be the mechanical property or the thermal property. In a case where the physical property to be measured is the mechanical property, the measuring apparatus 500 may be a nanoindenter or a micro-Vickers tester, and may measure the hardness or the modulus of elasticity. In a case where the physical property to be measured is the thermal property, the measuring apparatus 500 may measure the thermal diffusivity by using the laser flash method performed on a small area. In a case where the physical property to be measured is the electrical property, the measuring apparatus 500 may measure the permittivity.

The machine-learning model M1 created in this manner is stored in a storage portion, such as the SSD 104; and is used in the inference process performed by the estimation portion 2 in the inference phase.

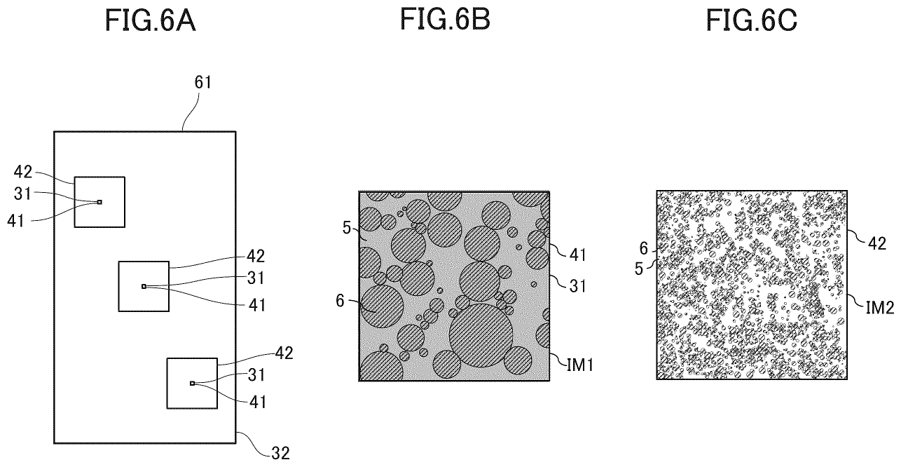

Next, the inference phase will be described. FIG. 6A is a schematic diagram of a sample 61 of the first embodiment. FIG. 6B is a schematic diagram of the image IM1 obtained by capturing an image of an image capture range 41 of the sample 61 of the first embodiment. FIG. 6C is a schematic diagram of the image IM2 obtained by capturing an image of an image capture range 42 of the sample 61 of the first embodiment.

The image IM1 illustrated in FIG. 6B is an image of any one of a plurality of (e.g., three) image capture ranges 41 of the sample 61 illustrated in FIG. 6A, captured with a magnification of 500 that is a first magnification, by using a microscope that is one example of the image capture apparatus 200.

The image capture range 41 is one example of a first image-capture range. The image IM1 is one example of a first image. For example, each of the image capture ranges 41 of the sample 61 has a size of 100 μm×100 μm. For reducing the variations in physical property of portions of the sample 61 that occur depending on the positions of the portions, images of three image capture ranges 41 are captured by using the image capture apparatus 200, so that a plurality of (e.g., three) images IM1 are obtained. Note that instead of the microscope, the images of the image capture ranges 41 may be captured by using an optical microscope, an SEM, a TEM, or an X-ray CT.

The magnification for capturing images may be set freely in accordance with the material, in consideration of the structure of the material that produces the physical property of the material. Specifically, the structure of the material involves the microscopic structure of the material, the phase, and the distribution of mixed filler. For example, the magnification for capturing images may be about 500 to 5000. In addition, before images of the sample 61 are captured, polishing, etching, or plasma treatment may be performed on the sample 61. In addition, the surface of the sample 61 may be covered with a thin electrically-conductive film, which is generally formed on an observation surface of an insulator material in a case where the insulator material is observed by using an SEM. Thus, the estimation portion 2 accepts the image IM1 of the image capture range 41 of the sample 61, captured with the first magnification.

The image IM2 illustrated in FIG. 6C is an image of any one of a plurality of (e.g., three) image capture ranges 42 of the sample 61 illustrated in FIG. 6A, captured with a magnification of 50 that is a second magnification lower than the first magnification, by using an optical microscope that is one example of the image capture apparatus 250.

The image capture range 42 is one example of a second image-capture range. The image IM2 is one example of a second image. For example, each of the image capture ranges 42 of the sample 61 has a size of 1 mm×1 mm. For reducing the variations in physical property of portions of the sample 61 that occur depending on the positions of the portions, images of a plurality of (e.g., three) image capture ranges 42 are captured by using the image capture apparatus 250, so that the plurality of images IM2 are obtained. Note that instead of the optical microscope, the images of the image capture ranges 42 may be captured by using, for example, an SEM or an X-ray CT. In addition, the image IM2 may be captured by using the same image capture apparatus and under the same condition as those for the image IM1. That is, the image IM1 and the image IM2 may be captured by using the same image capture apparatus. In addition, in a case where the image IM2 is to be obtained, a user may be allowed to visually recognize, on the display apparatus 300, the image capture range 41 of the image IM1 in the image capture range 42. That is, the CPU 101 may cause the display apparatus 300 to display the image capture range 41 of the image IM1 such that the image capture range 41 of the image IM1 is superimposed on the image IM2. Thus, the estimation portion 2 accepts the image IM2 of the image capture range 42 of the sample 61 larger than the image capture range 41, captured with the second magnification lower than the first magnification.

Also in the inference phase, the first magnification may be equal to or higher than 5 times the second magnification and equal to or lower than 20 times the second magnification. This is because less information is obtained if the second magnification is too close to the first magnification, and because the accuracy for estimating the physical property deteriorates if the second magnification is set too low. In the case where the second magnification is set too low, the accuracy deteriorates because it becomes difficult to obtain the distribution in the structure and the arrangement of the filler.

Then, in a range 31 of the sample 61 related to the image IM1 obtained by capturing an image of the image capture range 41, the physical-property value P1 of a physical property is measured by using the measuring apparatus 500. The range 31 is one example of a first range. The physical-property value P1 is one example of a first physical-property value. In the first embodiment, the electrical property (i.e., electrical resistance) of the range 31 of the sample 61 is measured, as the physical property of the sample 61, by using an SPM that serves as the measuring apparatus 500, and thereby the electrical resistance value is obtained as the physical-property value P1 of the range 31. Specifically, the current image distribution of the range 31 of the sample 61 is determined by using the SPM, then the resistance distribution of the range 31 is determined from the current image distribution of the range 31, and then the resistance distribution of the range 31 is averaged, so that the electrical resistance value of the range 31 is obtained as the physical-property value P1. Thus, the estimation portion 2 accepts the physical-property value P1 of the physical property of the range 31 of the sample 61.

The range 31 overlaps with the image capture range 41. Specifically, part or all of the range 31 overlaps with part or all of the image capture range 41. In the examples illustrated in FIGS. 6A and 6B, both of the range 31 and the image capture range 41 have the same rectangular shape and the same size. The range 31 and the image capture range 41 slightly deviate from each other, and part of the range 31 overlaps with part of the image capture range 41. In the first embodiment, since a plurality of (e.g., three) image capture ranges 41 are set in the sample 61, ranges 31 that are measurement ranges of a physical property are set correspondingly for the plurality of (e.g., three) image capture ranges 41. Thus, the physical property is measured for each of the plurality of (e.g., three) ranges 31, so that the plurality of (e.g., three) physical-property values P1 are obtained. In addition, in a case where the range 31 is to be determined, a user may be allowed to visually recognize the image capture range 41 on the display apparatus 300.

Then, the estimation portion 2 estimates the physical-property value P2 of a physical property of a range 32 of the sample 61 larger than the range 31, by using at least the image IM1, the physical-property value P1, and the image IM2. The range 32 is one example of a second range. The physical-property value P2 is one example of a second physical-property value.

The range 31 corresponds to a range of magnification from the first magnification to the second magnification. That is, the range 11 may be equal to or larger than the image capture range 41, and equal to or smaller than the image capture range 42.

In another case, the range 31 may be substantially equal to the image capture range 41. That is, the range 11 may be equal to or larger than 0.9 times the image capture range 41 and equal to or smaller than 1.1 times the image capture range 41.

In the first embodiment, an image of the image capture range 41 of the sample 61 is captured by using a microscope that belongs to an SPM, and an electrical resistance value is obtained from a current image distribution obtained in the same portion of the sample 61. Thus, the range 31 is substantially equal to the image capture range 41.

The position of the image capture range 41 and the range 31 may be determined by using a microscope that belongs to the measuring apparatus 500, or the image capture apparatus 200 that may be a microscope. In another case, the position of the image capture range 41 and the range 31 may be determined by using a mark (e.g., marking) formed in advance in the sample 61.

In the first embodiment, the physical-property value P2 of the physical property of the range 32 is estimated by the estimation portion 2 in the inference process. That is, the estimation portion 2 uses the learned machine-learning model M1 that uses the image IM1, the physical-property value P1, and the image IM2 as the input data IN2 for estimating the physical-property value P2 of the physical property, and that outputs the physical-property value P2 of the physical property as the output data OUT2. In the present embodiment, the physical-property value P2 of the physical property is an electrical resistance value of the electrical resistance of the range 32 of the sample 61.

In the first embodiment, the need for preparing the measuring apparatus 550 can be eliminated. The electrical resistance value that is a value of the electrical resistance of the range 32 of the sample 61 is obtained through the inference process performed by the estimation portion 2. In the first embodiment, the range 32 of the sample 61 is the whole of the sample 61.

In a case where the range 32 is significantly larger than the range 31 as in the first embodiment, it is generally difficult to measure the physical properties of the range 31 and the range 32 by using the same measuring apparatus 500. Thus, the electrical resistance that is the physical-property value P2 of the physical property of the range 32 is estimated by the estimation portion 2.

In the inference phase, the images IM1 and IM2, and the physical-property value P1 obtained in this manner are included in the input data IN2, and the physical-property value P2 is output as the output data OUT2.

Note that the input data IN2 may include a single image IM1, a single physical-property value P1, and a single image IM2. However, the input data IN2 may include a plurality of (e.g., three) images IM1, a plurality of (e.g., three) physical-property values P1, and a plurality of (e.g., three) images IM2. For reducing the variations of a material as described above, a plurality of (e.g., three) images IM1, a plurality of (e.g., three) physical-property values P1, and a plurality of images IM2 are obtained from a single sample 61, and the plurality of images IM1, the plurality of physical-property values P1, and the plurality of images IM2 constitute the input data IN2. The physical-property value P2 of the range 32 is obtained from the learned machine-learning model M1, by using the input data IN2.

Note that although the description has been made for the case where the physical property measured in each of the range 31 and the range 32 is the electrical property, the present disclosure is not limited to this. For example, the physical property measured in each of the range 31 and the range 32 may be the mechanical property or the thermal property. In a case where the physical property to be measured in the range 31 is the mechanical property, the measuring apparatus 500 may be a nanoindenter or a micro-Vickers tester, and may measure the hardness or the modulus of elasticity. In a case where the physical property to be measured in the range 31 is the thermal property, the measuring apparatus 500 may measure the thermal diffusivity by using the laser flash method performed on a small area. In a case where the physical property to be measured in the range 31 is the electrical property, the measuring apparatus 500 may measure the permittivity.

As described above, in the estimation phase, the estimation portion 2 obtains the input data IN2, which includes the image IM1, the physical-property value P1 measured in the range 31, and the image IM2 of the sample 61 whose physical property is to be estimated, by using the same method as that for the learning phase, and stores the input data IN2 in the SSD 104. Then, the estimation portion 2 infers the physical-property value P2, which is the output data OUT2, by using the input data IN2 stored in the SSD 104. Each of the image IM1, the physical-property value P1, and the image IM2 may be plural in number. However, it is necessary that the number of each of the images IM1, the physical-property values P1, and the images IM2 be equal to the number of a corresponding one of the images IM11, the physical property values P11, and the images IM2 that are input in a case where the machine-learning model M1, which is an estimation model, is trained. That is, it is necessary that the number of the images IM1, the number of the physical-property values P1, and the number of the images IM2 be respectively equal to the number of the images IM11, the number of the physical-property values P11, and the number of the images IM12 (the images IM11, the physical-property values P11, and the images IM12 are included in a single data set S1 in the learning phase). In this manner, the estimation portion 2 can estimate the physical property of the range 32 of the sample 61, from the learned machine-learning model M1 created in advance in the learning phase, by using the input data IN2 that has been input.

As described above, in the first embodiment, the estimation portion 2 accepts, as the input data IN2, three images IM1 that are one example of at least one first image, three physical-property values P1 that are one example of at least one first physical-property value, and three images IM2 that are one example of at least one second image. The estimation portion 2 estimates the physical-property value P2, based on the images IM1, the physical-property values P1, and the images IM2 accepted by the estimation portion 2.

Thus, in the first embodiment, since the estimation portion 2 estimates the physical-property value P2 in the inference phase, the need for preparing the measuring apparatus 550 can be eliminated. That is, since the time for setting the measuring apparatus 550, every time the sample 61 is made, for evaluating the sample 61 is saved, the efficiency for evaluating the sample 61 is increased. As a result, the accuracy for estimating the physical-property value P2 of the physical property of a macroscopic area of the sample is increased. In addition, even in a case where the physical-property value P2 can be measured by using the measuring apparatus 500, since the process for measuring the physical-property value P2 by using the measuring apparatus 500 can be eliminated, the efficiency for evaluating the sample 61 is increased.

### Second Embodiment

Next, a second embodiment will be described. Hereinafter, a component given the same reference symbol as that of a component of the above-described first embodiment has substantially the same structure and effects as those of the component of the first embodiment, unless otherwise specified; and thus, features different from those of the first embodiment will be mainly described.

Since the hardware configuration of the physical-property estimation system of the second embodiment is substantially the same as the hardware configuration of the physical-property estimation system 1000 of the first embodiment illustrated in FIG. 1, the description of the hardware configuration of the physical-property estimation system of the second embodiment will be omitted. In the second embodiment, in the learning phase and the inference phase, an image captured with a third magnification between the first magnification and the second magnification, and a physical property value of a physical property of a range that corresponds to the image are used as input data.

Also, in the second embodiment, the CPU 101 illustrated in FIG. 1 functions as the learning portion 1 and the estimation portion 2 illustrated in FIG. 2A, by executing the program 161. Specifically, the CPU 101 functions as the learning portion 1 in the learning phase, and as the estimation portion 2 in the inference phase. The learning portion 1 executes a learning method, and the estimation portion 2 executes a physical-property estimation method. In addition, an object on which the inference is performed is expressed as a sample, and an object which is used for obtaining the learning data is expressed as a test piece. For example, the sample is a prototype.

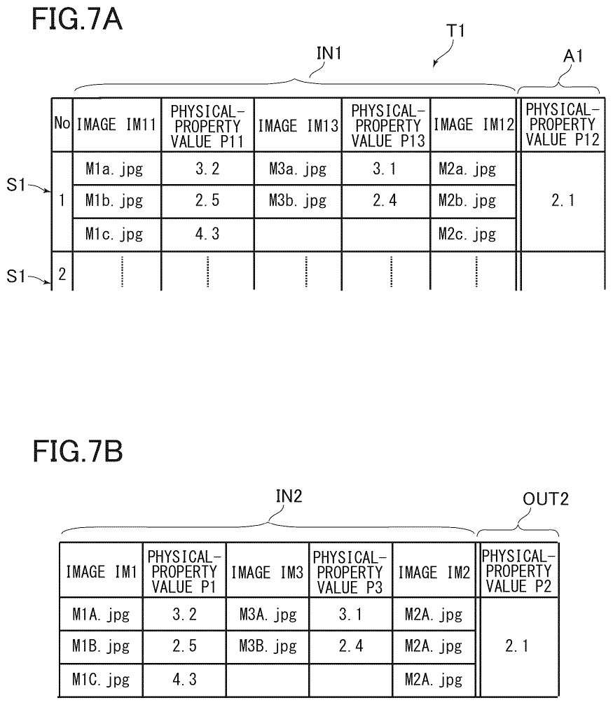

FIG. 7A is a diagram illustrating one example of learning data T1 of the second embodiment. FIG. 7B is a diagram illustrating one example of input data IN2 that is used for the inference in the second embodiment, and of output data OUT2 that is an inference result.

The learning portion 1 performs the supervised learning in the learning phase, as the machine learning. The learning portion 1 performs the supervised machine learning by using the learning data T1, and creates the learned machine-learning model M1 illustrated in FIG. 2A. The learning data T1 includes a plurality of data sets S1, each of which includes input data IN1 and correct answer data A1. The machine-learning model M1 is stored, for example, in the SSD 104 illustrated in FIG. 1. The estimation portion 2 performs the inference on the input data IN2 in the inference phase, by using the learned machine-learning model M1; and outputs the output data OUT2 that is an inference result.

Each of the plurality of data sets S1 includes, as the input data IN1, at least one image IM11 of a microscopic area of a test piece, at least one physical-property value P11 of a physical property of a microscopic area of the test piece, at least one image IM13 of an intermediate area of the test piece, the size of which is between the size of the microscopic area and the size of a macroscopic area of a test piece, at least one physical-property value P13 of a physical property of the intermediate area of the test piece, and at least one image IM12 of the macroscopic area of the test piece. In addition, each of the plurality of data sets S1 includes, as the correct answer data A1, a physical-property value P12 of a physical property of a macroscopic area of a test piece.

The image IM11 is digital data, such as a captured image, obtained by the image capture apparatus 200 capturing an image of a test piece with a first magnification. The image IM13 is digital data, such as a captured image, obtained by the image capture apparatus 200 capturing an image of the test piece with a third magnification lower than the first magnification and higher than a second magnification. The third magnification is a magnification between the first magnification and the second magnification. The image IM12 is digital data, such as a captured image, obtained by the image capture apparatus 250 capturing an image of a test piece with the second magnification lower than the first magnification and the third magnification. The image capture apparatus 200 captures an image of a test piece with a magnification higher than that of the image capture apparatus 250. All of the image IM11, the image IM12, and the image IM13 are images captured with magnifications higher than 1.

The input data IN2 includes at least one image IM1 of a microscopic area of a sample, at least one physical-property value P1 of a physical property of a microscopic area of the sample, at least one image IM3 of an intermediate area of the sample, at least one physical-property value P3 of a physical property of the intermediate area of the sample, and at least one image IM2 of a macroscopic area of the sample. The output data OUT2 is a physical-property value P2 of a physical property of a macroscopic area of the sample.

The image IM1 is digital data, such as a captured image, obtained by the image capture apparatus 200 capturing an image of the sample with a first magnification. The image IM3 is digital data, such as a captured image, obtained by the image capture apparatus 200 capturing an image of the sample with a third magnification. The image IM2 is digital data, such as a captured image, obtained by the image capture apparatus 250 capturing an image of the sample with a second magnification. The image capture apparatus 200 captures an image of the sample with a magnification higher than that of the image capture apparatus 250. All of the image IM1, the image IM2, and the image IM3 are images captured with magnifications higher than 1.

The number of the images IM1 is the same as the number of the images IM11 of a single data set S1. The number of the physical-property values P1 is the same as the number of the physical-property values P11 of a single data set S1. The number of the images IM3 is the same as the number of the images IM13 of a single data set S1. The number of the physical-property values P3 is the same as the number of the physical-property values P13 of a single data set S1. The number of the images IM2 is the same as the number of the images IM12 of a single data set S1.

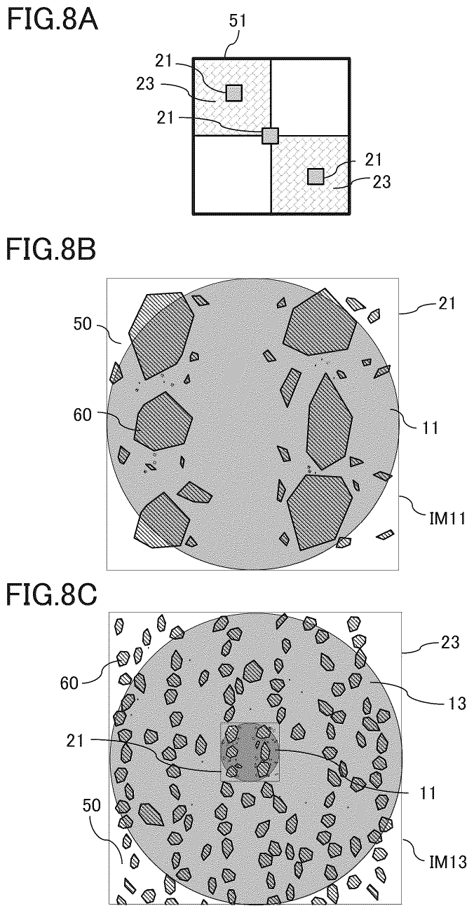

FIG. 8A is a schematic diagram of a small test piece 51 of the second embodiment. FIG. 8B is a schematic diagram of an image capture range 21 of the small test piece 51 of the second embodiment, and of an image IM11 obtained by capturing an image of the image capture range 21. FIG. 8C is a schematic diagram of an image capture range 23 of the small test piece 51 of the second embodiment, and of an image IM13 obtained by capturing an image of the image capture range 23.

In the second embodiment, each of the test piece used for the learning and the sample used for the inference is a composite member produced by dispersing magnesium-oxide (MgO) fillers 60 having a predetermined particle-diameter distribution, in a thermosetting resin material 50 at a predetermined ratio. The estimation portion 2 estimates the value of thermal diffusivity of the sample, as the physical-property value of a physical property of the sample.

Next, a method of making the test piece and the sample will be described. A liquid resin material is mixed with the MgO filler at a predetermined ratio and agitated, and then the liquid mixture is spread, like a sheet, over one of a pair of electrodes. After that, the other electrode is put on the liquid mixture so that the liquid mixture is sandwiched between the pair of electrodes, and an electric field is applied between the electrodes for facilitating the alignment of the filler. Then, the liquid mixture is cured by heating the mixture, and the electrodes are peeled off from the cured composite member. In this manner, the sheet-like composite member is obtained.

Hereinafter, a method of obtaining the learning data T1 used for the machine learning will be described. The small test piece 51 illustrated in FIG. 8A is made by cutting the composite member formed like a sheet, into thin pieces by using a microtome. In size, the small test piece 51 has an area of 1 mm×1 mm, and a thickness of 1 μm.

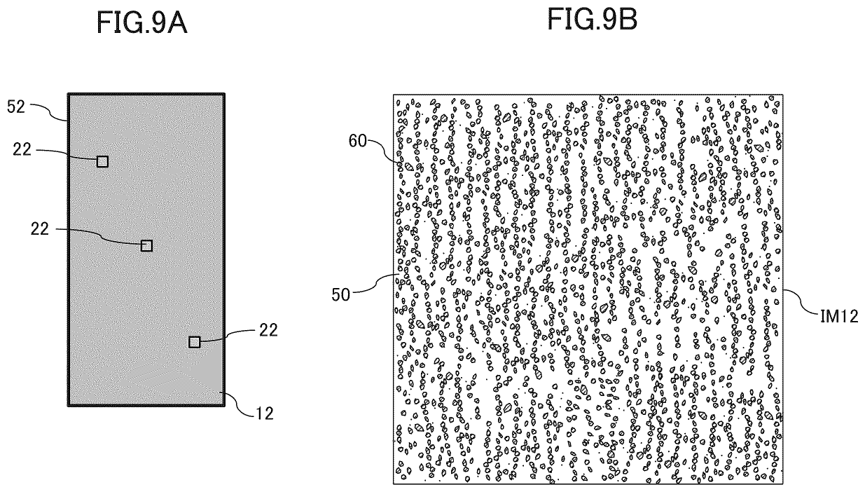

FIG. 9A is a schematic diagram of a standard test piece 52 of the second embodiment. FIG. 9B is a schematic diagram of the image IM12 obtained by capturing an image of an image capture range 22 of the standard test piece 52 of the second embodiment. Note that the small test piece 51 illustrated in FIG. 8A and the standard test piece 52 illustrated in FIG. 9A may be the same test piece, or may be different test pieces made by using the same material and method and substantially equal to each other. In the present embodiment, the standard test piece 52 is made of substantially the same material as that of the small test piece 51; and in size, has an area of 30 mm×15 mm and a thickness of 1 mm.

The image IM11 illustrated in FIG. 8B is an image of any one of a plurality of (e.g., three) image capture ranges 21 of the small test piece 51 illustrated in FIG. 8A, captured with a magnification of 500 that is a first magnification, by using an SEM that is one example of the image capture apparatus 200. For example, each of the image capture ranges 21 of the small test piece 51 has a size of 100 μm×100 μm. For reducing the variations in physical property of portions of the small test piece 51 that occur depending on the positions of the portions, images of three image capture ranges 21 are captured by using the image capture apparatus 200, so that a plurality of (e.g., three) images IM11 are obtained.

The image IM13 illustrated in FIG. 8C is an image of any one of a plurality of (e.g., two) image capture ranges 23 of the small test piece 51 illustrated in FIG. 8A, captured with a magnification of 100 that is a third magnification, by using an SEM that is one example of the image capture apparatus 200. For example, each of the image capture ranges 23 of the small test piece 51 has a size of 500 μm×500 μm. For reducing the variations in physical property of portions of the small test piece 51 that occur depending on the positions of the portions, images of two image capture ranges 23 are captured by using the image capture apparatus 200, so that a plurality of (e.g., two) images IM13 are obtained. Note that an image capture range 23 of the image IM13 may or may not include an image capture range 21 of the image IM11. In addition, instead of the SEM, the images of the image capture ranges 21 or 23 may be captured by using, for example, an optical microscope, a microscope, a TEM, or an X-ray CT. In addition, although the description has been made for the case where the image IM11 and the image IM13 are captured by using the same image capture apparatus 200, the present disclosure is not limited to this. For example, the image IM11 and the image IM13 may be captured by using different image capture apparatuses.

The image IM12 illustrated in FIG. 9B is an image of any one of a plurality of (e.g., three) image capture ranges 22 of the standard test piece 52 illustrated in FIG. 9A, captured with a magnification of 25 that is a second magnification lower than the first magnification and the third magnification, by using an optical microscope that is one example of the image capture apparatus 250.

For example, each of the image capture ranges 22 of the standard test piece 52 has a size of 2 mm×2 mm. For reducing the variations in physical property of portions of the standard test piece 52 that occur depending on the positions of the portions, images of a plurality of (e.g., three) image capture ranges 22 are captured by using the image capture apparatus 250, so that the plurality of images IM12 are obtained. Note that instead of the optical microscope, the images of the image capture ranges 22 may be captured by using, for example, an SEM or an X-ray CT. In addition, the image IM12 may be captured by using the same image capture apparatus and under the same condition as those for the images IM11 and IM13. That is, the image IM11, the image IM12, and the image IM13 may be captured by using the same image capture apparatus.

The first magnification may be equal to or higher than 5 times the second magnification and equal to or lower than 20 times the second magnification. This is because less information is obtained if the second magnification is too close to the first magnification, and because the accuracy for estimating the physical property deteriorates if the second magnification is set too low. In the case where the second magnification is set too low, the accuracy deteriorates because it becomes difficult to obtain the distribution in the structure and the arrangement of the filler.

Then, the physical-property value P11 of a physical property is measured by using the measuring apparatus 500 in a range 11 of the small test piece 51 related to the image IM11 obtained by capturing an image of the image capture range 21, and the physical-property value P13 of a physical property is measured by using the measuring apparatus 500 in a range 13 of the small test piece 51 related to the image IM13 obtained by capturing an image of the image capture range 23.

In the second embodiment, the thermal property of the range 11 and the range 13 of the small test piece 51 is measured, as the physical property of the small test piece 51. For example, the thermal diffusivity of the range 11 and the range 13 is measured by using the measuring apparatus 500, and thereby values of thermal diffusivity are obtained as the physical-property value P11 of the range 11 and the physical-property value P13 of the range 13.

Specifically, the physical properties of the range 11 and the range 13 can be measured by using the periodic heating method that uses a laser beam, which is a known technology for measuring the thermal diffusivity of a thin film (Kazuya Okamoto, Bulletin of Tokyo University of Science, Yamaguchi, 2018, (1), pages 61 to 65). For example, the range 11 in which the thermal diffusivity is measured has a size φ of 100 μm, and the range 13 in which the thermal diffusivity is measured has a size φ of 500 μm.

The range 11 overlaps with the image capture range 21. Specifically, part or all of the range 11 overlaps with part or all of the image capture range 21. The range 13 overlaps with the image capture range 23. Specifically, part or all of the range 13 overlaps with part or all of the image capture range 23.

In the example illustrated in FIG. 8B, the image capture range 21 has a rectangular shape, the range 11 has a circular shape, and the range 11 is located inside the image capture range 21. In the example illustrated in FIG. 8C, the image capture range 23 has a rectangular shape, the range 13 has a circular shape, and the range 13 is located inside the image capture range 23.

In the second embodiment, since a plurality of (e.g., three) image capture ranges 21 are set in the small test piece 51, the ranges 11 that are measurement ranges of a physical property are set correspondingly for the plurality of (e.g., three) image capture ranges 21. Thus, the physical property is measured for each of the plurality of (e.g., three) ranges 11, so that the plurality of (e.g., three) physical-property values P11 are obtained. Similarly, since a plurality of (e.g., two) image capture ranges 23 are set in the small test piece 51, the ranges 13 that are measurement ranges of a physical property are set correspondingly for the plurality of (e.g., two) image capture ranges 23. Thus, the physical property is measured for each of the plurality of (e.g., two) ranges 13, so that the plurality of (e.g., two) physical-property values P13 are obtained.

The range 11 corresponds to a range of magnification from the first magnification to the second magnification. That is, the range 11 may be equal to or larger than the image capture range 21, and equal to or smaller than the image capture range 22.

In another case, the range 11 may be substantially equal to the image capture range 21. That is, the range 11 may be equal to or larger than 0.9 times the image capture range 21 and equal to or smaller than 1.1 times the image capture range 21.

In the second embodiment, the physical-property value P12, which is the correct answer data A1 of the learning data T1, is obtained by using the measuring apparatus 550 different from the measuring apparatus 500. The physical-property value P12 is obtained by measuring a range 12 of the standard test piece 52 by using the measuring apparatus 550. The range 12 is a range larger than each of the range 11 and the range 13. In the present embodiment, the physical-property value P12 is a value of thermal diffusivity of the range 12 of the standard test piece 52.

The value of thermal diffusivity, which is a physical-property value of the range 12 of the standard test piece 52, is calculated by using the temperature gradient method, from a thermal conductivity and a specific heat measured separately. The thermal conductivity is determined from the temperature gradient between one end and the other end of the standard test piece 52 in the direction of the long side (30 mm) of the standard test piece 52. In the second embodiment, the range 12 of the standard test piece 52 is the whole of the standard test piece 52.

In a case where the range 12 is significantly larger than the range 11 as in the second embodiment, it is generally difficult to measure the physical property of the range 11 and the range 12 by using the same measuring apparatus 500. Thus, the same physical property (i.e., thermal diffusivity) is measured for the range 11 and the range 12 by using different methods by using the different measuring apparatuses 500 and 550.

In the learning phase, the images IM11, IM12, and IM13 and the physical-property values P11, P12, and P13 are obtained from a plurality of small test pieces 51 and a plurality of standard test pieces 52, which have the different amounts of mixed filler, and different processes for producing the material that involve a mixing condition, an orientation voltage, and a heat-treatment condition. Thus, a plurality of data sets S1 is created, and constitutes the learning data T1. In this case, each of the plurality of data sets S1 includes the image IM11, the physical-property value P11, the image IM13, the physical-property value P13, and the image IM12, as the input data IN1; and includes the physical-property value P12, as the correct answer data A1.

Note that in a single data set S1, the input data IN1 may include a single image IM11, a single physical-property value P11, a single image IM13, a single physical-property value P13, and a single image IM12. However, the single data set S1 may include a plurality of images IM11, a plurality of physical-property values P11, a plurality of images IM13, a plurality of physical-property values P13, and a plurality of images IM12. For reducing the variations of a material as described above, a plurality of (e.g., three) images IM11, a plurality of (e.g., three) physical-property values P11, a plurality of (e.g., two) images IM13, and a plurality of (e.g., two) physical-property values P13 are obtained from a single small test piece 51, and a plurality of (e.g., three) images IM12 are obtained from a single standard test piece 52. The plurality of images IM11, the plurality of physical-property values P11, the plurality of images IM13, the plurality of physical-property values P13, and the plurality of images IM12 constitute the input data IN1 of a single data set S1. The supervised machine learning is performed on the input data IN1 by using the physical-property value P12, measured in the range 12, as the correct answer data A1, so that the machine-learning model M1 used for estimating a physical-property value is obtained.

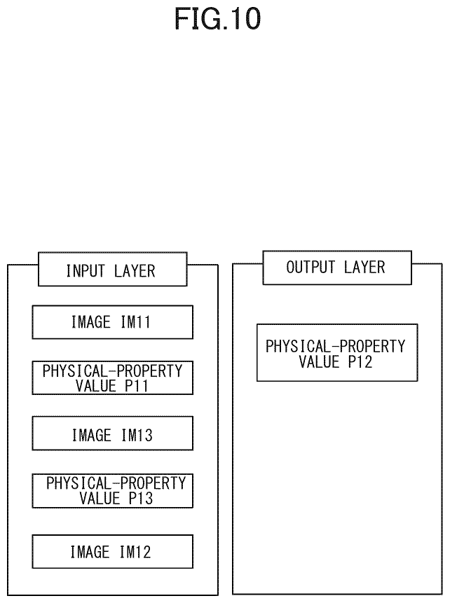

Next, a specific example of the learning method of the learning portion 1 will be described. For example, in the machine learning performed by the learning portion 1, a regression model that uses the convolutional neural network (CNN) is used as in the first embodiment. FIG. 10 is a diagram illustrating the machine learning performed in the second embodiment. FIG. 10 illustrates an input layer and an output layer of a regression model that uses the CNN. The input layer includes three images IM11, three physical-property values P11, two images IM13, two physical-property values P13, and three images IM12. The learning portion 1 performs the machine learning so that a single physical-property value P12 is output via a plurality of intermediate layers, so that the learned machine-learning model M1 that is an estimation model is created. Note that the method of the machine learning is not limited to the CNN. In addition, the number of the data sets S1 may be equal to or larger than 50 for increasing the accuracy for estimating the physical property. For example, the number of the data sets S1 may be equal to or larger than 100.

In this manner, the magnification is changed step by step, so that more detailed relationship between the structure and the physical property of the small test piece 51 is input. As a result, it becomes possible to estimate the physical property of the sample with high accuracy. For example, in a case where fillers with different sizes are contained in a material, the arrangement information on small fillers and large fillers may not be obtained sufficiently from a single image. In such a case, if images with magnifications changed step by step in accordance with the filler size, and physical-property values measured in ranges related to the images are input, the information on the arrangement of the filler with each size and on the physical property produced by the arrangement are added. As a result, the machine-learning model M1 that can estimate the physical property with higher accuracy is created.

The machine-learning model M1 created in this manner is stored in a storage portion, such as the SSD 104; and is used in the inference process performed by the estimation portion 2 in the inference phase.

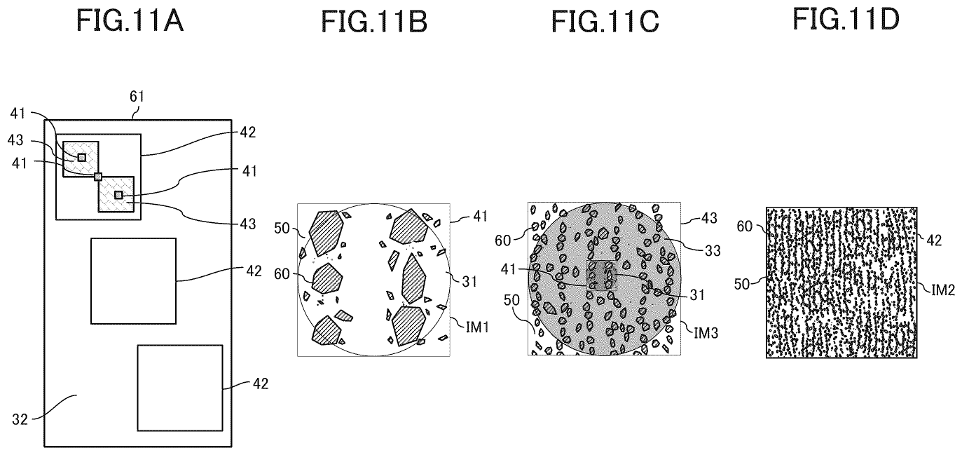

Next, the inference phase will be described. FIG. 11A is a schematic diagram of a sample 61 of the second embodiment. FIG. 11B is a schematic diagram of an image IM1 obtained by capturing an image of an image capture range 41 of the sample 61 of the second embodiment. FIG. 11C is a schematic diagram of an image IM3 obtained by capturing an image of an image capture range 43 of the sample 61 of the second embodiment. FIG. 11D is a schematic diagram of an image IM2 obtained by capturing an image of an image capture range 42 of the sample 61 of the second embodiment.

The image IM1 illustrated in FIG. 11B is an image of any one of a plurality of (e.g., three) image capture ranges 41 of the sample 61 illustrated in FIG. 11A, captured with a magnification of 500 that is a first magnification, by using an SEM that is one example of the image capture apparatus 200.

The image capture range 41 is one example of a first image-capture range. The image IM1 is one example of a first image. For example, each of the image capture ranges 41 of the sample 61 has a size of 100 μm×100 μm. For reducing the variations in physical property of portions of the sample 61 that occur depending on the positions of the portions, images of three image capture ranges 41 are captured by using the image capture apparatus 200, so that a plurality of (e.g., three) images IM1 are obtained. Note that instead of the SEM, the images of the image capture ranges 41 may be captured by using, for example, an optical microscope, a microscope, a TEM, or an X-ray CT.

The magnification for capturing images may be set freely in accordance with the material, in consideration of the structure of the material that produces the physical property of the material. Specifically, the structure of the material involves the microscopic structure of the material, the phase, and the distribution of mixed filler. For example, the magnification for capturing images may be about 500 to 5000. Thus, the estimation portion 2 accepts the image IM1 of the image capture range 41 of the sample 61, captured with the first magnification.

The image IM3 illustrated in FIG. 11C is an image of any one of a plurality of (e.g., two) image capture ranges 43 of the sample 61 illustrated in FIG. 11A, captured with a magnification of 100 that is a third magnification, by using an SEM that is one example of the image capture apparatus 200.

The image capture range 43 of the sample 61 is one example of a third image-capture range. The image IM3 is one example of a third image. For example, each of the image capture ranges 43 of the sample 61 has a size of 500 μm×500 μm. For reducing the variations in physical property of portions of the sample 61 that occur depending on the positions of the portions, images of two image capture ranges 43 are captured by using the image capture apparatus 200, so that a plurality of (e.g., two) images IM3 are obtained. Note that an image capture range 43 of the image IM3 may or may not include an image capture range 41 of the image IM1. In addition, instead of the SEM, the images of the image capture ranges 41 or 43 may be captured by using, for example, an optical microscope, a microscope, a TEM, or an X-ray CT. In addition, although the description has been made for the case where the image IM1 and the image IM3 are captured by using the same image capture apparatus 200, the present disclosure is not limited to this. For example, the image IM1 and the image IM3 may be captured by using different image capture apparatuses. Thus, the estimation portion 2 accepts the image IM3 of the image capture range 43 of the sample 61 larger than the image capture range 41 and smaller than the image capture range 42, captured with the third magnification between the first magnification and a second magnification.

The image IM2 illustrated in FIG. 11D is an image of any one of a plurality of (e.g., three) image capture ranges 42 of the sample 61 illustrated in FIG. 11A, captured with a magnification of 25 that is the second magnification lower than the first magnification, by using an optical microscope that is one example of the image capture apparatus 250.

The image capture range 42 is one example of a second image-capture range. The image IM2 is one example of a second image. For example, each of the image capture ranges 42 of the sample 61 has a size of 2 mm×2 mm. For reducing the variations in physical property of portions of the sample 61 that occur depending on the positions of the portions, images of a plurality of (e.g., three) image capture ranges 42 are captured by using the image capture apparatus 250, so that the plurality of images IM2 are obtained. Note that instead of the optical microscope, the images of the image capture ranges 42 may be captured by using, for example, an SEM or an X-ray CT. In addition, the image IM2 may be captured by using the same image capture apparatus and under the same condition as those for the images IM1 and IM3. That is, the image IM1, the image IM2, and the image IM3 may be captured by using the same image capture apparatus. Thus, the estimation portion 2 accepts the image IM2 of the image capture range 42 of the sample 61 larger than the image capture range 41, captured with the second magnification lower than the first magnification and the third magnification.

Also in the inference phase, the first magnification may be equal to or higher than 5 times the second magnification and equal to or lower than 20 times the second magnification. This is because less information is obtained if the second magnification is too close to the first magnification, and because the accuracy for estimating the physical property deteriorates if the second magnification is set too low. In the case where the second magnification is set too low, the accuracy deteriorates because it becomes difficult to obtain the distribution in the structure and the arrangement of the filler.

Then, the physical-property value P1 of a physical property is measured by using the measuring apparatus 500 in a range 31 of the sample 61 related to the image IM1 obtained by capturing an image of the image capture range 41, and the physical-property value P3 of a physical property is measured by using the measuring apparatus 500 in a range 33 of the sample 61 related to the image IM3 obtained by capturing an image of the image capture range 43. The range 31 is one example of a first range. The physical-property value P1 is one example of a first physical-property value. The range 33 is one example of a third range. The physical-property value P3 is one example of a third physical-property value. The range 33 is a range larger than the range 31 and smaller than the range 32.

In the second embodiment, the thermal property of the range 31 and the range 33 of the sample 61 is measured, as the physical property of the sample 61. For example, the thermal diffusivity of the range 31 and the range 33 is measured by using the measuring apparatus 500, and thereby values of thermal diffusivity are obtained as the physical-property value P1 of the range 31 and the physical-property value P3 of the range 33. The method of measuring the thermal diffusivity is the same as the method for obtaining the physical-property values P11 and P13. For example, the range 31 in which the thermal diffusivity is measured has a size φ of 100 μm, and the range 33 in which the thermal diffusivity is measured has a size φ of 500 μm. Thus, the estimation portion 2 accepts the physical-property value P1 of the physical property of the range 31 of the sample 61, and the physical-property value P3 of the physical property of the range 33 of the sample 61.

The range 31 overlaps with the image capture range 41. Specifically, part or all of the range 31 overlaps with part or all of the image capture range 41. The range 33 overlaps with the image capture range 43. Specifically, part or all of the range 33 overlaps with part or all of the image capture range 43.

In the example illustrated in FIG. 11B, the image capture range 41 has a rectangular shape, the range 31 has a circular shape, and the range 31 is located inside the image capture range 41. That is, the range 31 is included in the image capture range 41. In addition, in the example illustrated in FIG. 11C, the image capture range 43 has a rectangular shape, the range 33 has a circular shape, and the range 33 is located inside the image capture range 43. That is, the range 33 is included in the image capture range 43.

In the second embodiment, since a plurality of (e.g., three) image capture ranges 41 are set in the sample 61, the ranges 31 that are measurement ranges of a physical property are set correspondingly for the plurality of (e.g., three) image capture ranges 41. Thus, the physical property is measured for each of the plurality of (e.g., three) ranges 31, so that the plurality of (e.g., three) physical-property values P1 are obtained. Similarly, since a plurality of (e.g., two) image capture ranges 43 are set in the sample 61, the ranges 33 that are measurement ranges of a physical property are set correspondingly for the plurality of (e.g., two) image capture ranges 43. Thus, the physical property is measured for each of the plurality of (e.g., two) ranges 33, so that the plurality of (e.g., two) physical-property values P3 are obtained.

Then, the estimation portion 2 estimates the physical-property value P2 of a physical property of a range 32 of the sample 61 larger than the range 31 and the range 33, by using at least the image IM1, the physical-property value P1, the image IM3, the physical-property value P3, and the image IM2. The range 32 is one example of a second range. The physical-property value P2 is one example of a second physical-property value.

The range 31 corresponds to a range of magnification from the first magnification to the second magnification. That is, the range 31 may be equal to or larger than the image capture range 41, and equal to or smaller than the image capture range 42.

In another case, the range 31 may be substantially equal to the image capture range 41. That is, the range 31 may be equal to or larger than 0.9 times the image capture range 41 and equal to or smaller than 1.1 times the image capture range 41.

In the second embodiment, the physical-property value P2 of the physical property of the range 32 is estimated by the estimation portion 2 in the inference process. That is, the estimation portion 2 uses the learned machine-learning model M1 that uses the image IM1, the physical-property value P1, the image IM3, the physical-property value P3, and the image IM2 as the input data IN2 for estimating the physical-property value P2 of the physical property, and that outputs the physical-property value P2 of the physical property as the output data OUT2. In the present embodiment, the physical-property value P2 of the physical property is a value of thermal diffusivity of the range 32 of the sample 61.

In the second embodiment, the need for preparing the measuring apparatus 550 can be eliminated. The value of thermal diffusivity of the range 32 of the sample 61 is obtained through the inference process performed by the estimation portion 2. In the second embodiment, the range 32 of the sample 61 is the whole of the sample 61.

In a case where the range 32 is significantly larger than the range 31 as in the second embodiment, it is generally difficult to measure the physical properties of the range 31 and the range 32 by using the same measuring apparatus 500. Thus, the value of thermal diffusivity that is the physical-property value P2 of the physical property of the range 32 is estimated by the estimation portion 2.

In the inference phase, the images IM1, IM2 and IM3, and the physical-property values P1 and P3 obtained in this manner are included in the input data IN2, and the physical-property value P2 is output as the output data OUT2.

Note that the input data IN2 may include a single image IM1, a single physical-property value P1, a single image IM3, a single physical-property value P3, and a single image IM2. However, the input data IN2 may include a plurality of images IM1, a plurality of physical-property values P1, a plurality of images IM3, a plurality of physical-property values P3, and a plurality of images IM2. For reducing the variations of a material as described above, a plurality of images IM1, a plurality of physical-property values P1, a plurality of images IM3, a plurality of physical-property values P3, and a plurality of images IM2 are obtained from a single sample 61, and the plurality of images IM1, the plurality of physical-property values P1, the plurality of images IM3, the plurality of physical-property values P3, and the plurality of images IM2 constitute the input data IN2. The physical-property value P2 of the range 32 is obtained from the learned machine-learning model M1, by using the input data IN2.

In the estimation phase, the estimation portion 2 obtains the input data IN2, which includes the image IM1, the physical-property value P1 measured in the range 31, the image IM3, the physical-property value P3 measured in the range 33, and the image IM2 of the sample 61 whose physical property is to be estimated, by using the same method as that for the learning phase, and stores the input data IN2 in the SSD 104. Then, the estimation portion 2 infers the physical-property value P2, which is the output data OUT2, by using the input data IN2 stored in the SSD 104. Each of the image IM1, the physical-property value P1, the image IM3, the physical-property value P3, and the image IM2 may be plural in number. However, it is necessary that the number of each of the images IM1, the physical-property values P1, the images IM3, the physical-property values P3, and the images IM2 be equal to the number of a corresponding one of the images IM11, the physical-property values P11, the images IM13, the physical-property values P13, and the images IM12 that are input in a case where the machine-learning model M1, which is an estimation model, is trained. That is, it is necessary that the number of the images IM1, the number of the physical-property values P1, the number of the images IM3, the number of the physical-property values P3, and the number of the images IM2 be respectively equal to the number of the images IM11, the number of the physical-property values P11, the number of the images IM13, the number of the physical-property values P13, and the number of the images IM12 (the images IM11, the physical-property values P11, the images IM13, the physical-property values P13, and the images IM12 are included in a single data set S1 in the learning phase). In this manner, the estimation portion 2 can estimate the physical property of the range 32 of the sample 61, from the learned machine-learning model M1 created in advance in the learning phase, by using the input data IN2 that has been input.

As described above, in the second embodiment, the estimation portion 2 accepts, as the input data IN2, three images IM1 that are one example of at least one first image, three physical-property values P1 that are one example of at least one first physical-property value, two images IM3 that are one example of at least one third image, two physical-property values P3 that are one example of at least one third physical-property value, and three images IM2 that are one example of at least one second image. The estimation portion 2 estimates the physical-property value P2, based on the image IM1, the physical-property value P1, the image IM3, the physical-property value P3, and the image IM2 accepted by the estimation portion 2.

Thus, in the second embodiment, since the estimation portion 2 estimates the physical-property value P2 in the inference phase, the need for preparing the measuring apparatus 550 can be eliminated. That is, since the time for setting the measuring apparatus 550, every time the sample 61 is made, for evaluating the sample 61 is saved, the efficiency for evaluating the sample 61 is increased. As a result, the accuracy for estimating the physical-property value P2 of the physical property of a macroscopic area of the sample is increased. In addition, even in a case where the physical-property value P2 can be measured by using the measuring apparatus 500, since the process for measuring the physical-property value P2 by using the measuring apparatus 500 can be eliminated, the efficiency for evaluating the sample 61 is increased.

### Third Embodiment

Next, a third embodiment will be described. Hereinafter, a component given the same reference symbol as that of a component of the above-described various embodiments has substantially the same structure and effects as those of the component of the first embodiment, unless otherwise specified; and thus, features different from those of the first embodiment will be mainly described.

Since the hardware configuration of the physical-property estimation system of the third embodiment is substantially the same as the hardware configuration of the physical-property estimation system 1000 of the first embodiment illustrated in FIG. 1, the description of the hardware configuration of the physical-property estimation system of the third embodiment will be omitted. In the third embodiment, in the learning phase and the inference phase, a plurality of physical-property values of the first range whose types are different from each other is used as input data.

Also in the third embodiment, the CPU 101 illustrated in FIG. 1 functions as the learning portion 1 and the estimation portion 2 illustrated in FIG. 2A, by executing the program 161. Specifically, the CPU 101 functions as the learning portion 1 in the learning phase, and as the estimation portion 2 in the inference phase. The learning portion 1 executes a learning method, and the estimation portion 2 executes a physical-property estimation method. In addition, an object on which the inference is performed is expressed as a sample, and an object which is used for obtaining the learning data is expressed as a test piece. For example, the sample is a prototype.

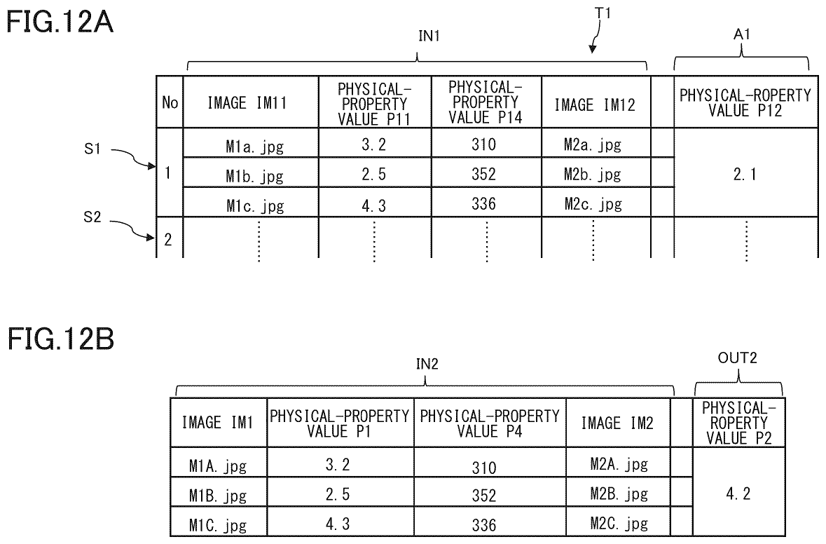

FIG. 12A is a diagram illustrating one example of learning data T1 of the third embodiment. FIG. 12B is a diagram illustrating one example of input data IN2 that is used for the inference in the third embodiment, and of output data OUT2 that is an inference result.

The learning portion 1 performs the supervised learning in the learning phase, as the machine learning. The learning portion 1 performs the supervised machine learning by using the learning data T1, and creates the learned machine-learning model M1 illustrated in FIG. 2A. The learning data T1 includes a plurality of data sets S1, each of which includes input data IN1 and correct answer data A1. The machine-learning model M1 is stored, for example, in the SSD 104 illustrated in FIG. 1. The estimation portion 2 performs the inference on the input data IN2 in the inference phase, by using the learned machine-learning model M1; and outputs the output data OUT2 that is an inference result.

In the third embodiment, a physical property that corresponds to the physical-property value P11 described in the first embodiment is referred to as a first physical property. Each of the plurality of data sets S1 includes, as the input data IN1, at least one image IM11 of a microscopic area of a test piece, at least one physical-property value P11 of the first physical property of a microscopic area of the test piece, at least one physical-property value P14 of a second physical property of the microscopic area of the test piece, and at least one image IM12 of a macroscopic area of a test piece.

The second physical property is a physical property whose type is different from the type of the first physical property. As described in the first embodiment, the physical property is a property, such as a mechanical property, an electrical property, a thermal property, a magnetic property, or an optical property. The first physical property and the second physical property may be properties different from each other. For example, the first physical property may be a mechanical property, and the second physical property may be an electrical property. In addition, the first physical property and the second physical property may be properties equal to each other, but may have different indicators. For example, the first physical property and the second physical property are both mechanical properties and in correlation with each other, and in this case, the first physical property may be Young's modulus and the second physical property may be hardness. Examples of the hardness include Vickers hardness, Brinell hardness, and Rockwell hardness. That is, the physical-property value P14 corresponds to a physical property that is different from the first physical property that correspond to the physical-property value P11.

In addition, each of the plurality of data sets S1 includes, as the correct answer data A1, a physical-property value P12 of a physical property of a macroscopic area of a test piece. The physical property that corresponds to the physical-property value P12 may be the first physical property.

The image IM11 is digital data, such as a captured image, obtained by the image capture apparatus 200 capturing an image of a test piece with a first magnification. The image IM12 is digital data, such as a captured image, obtained by the image capture apparatus 250 capturing an image of a test piece with a second magnification lower than the first magnification. The image capture apparatus 200 captures an image of a test piece with a magnification higher than that of the image capture apparatus 250. Both of the image IM11 and the image IM12 are images captured with magnifications higher than 1.

The input data IN2 includes at least one image IM1 of a microscopic area of a sample, at least one physical-property value P1 of the first physical property of a microscopic area of the sample, at least one physical-property value P4 of the second physical property of the microscopic area of the sample, and at least one image IM2 of a macroscopic area of the sample. The physical-property value P1 is one example of a first physical-property value. The physical-property value P4 is one example of a fourth physical-property value. The output data OUT2 is a physical-property value P2 of the first physical property of a macroscopic area. The physical-property value P2 is one example of a second physical-property value.

The image IM1 is digital data, such as a captured image, obtained by the image capture apparatus 200 capturing an image of the sample with a first magnification. The image IM2 is digital data, such as a captured image, obtained by the image capture apparatus 250 capturing an image of the sample with a second magnification. The image capture apparatus 200 captures an image of the sample with a magnification higher than that of the image capture apparatus 250. Both of the image IM1 and the image IM2 are images captured with magnifications higher than 1.

The number of the images IM1 is the same as the number of the images IM11 of a single data set S1. The number of the physical-property values P1 is the same as the number of the physical-property values P11 of a single data set S1. The number of the physical-property values P4 is the same as the number of the physical-property values P14 of a single data set S1. The number of the images IM2 is the same as the number of the images IM12 of a single data set S1.

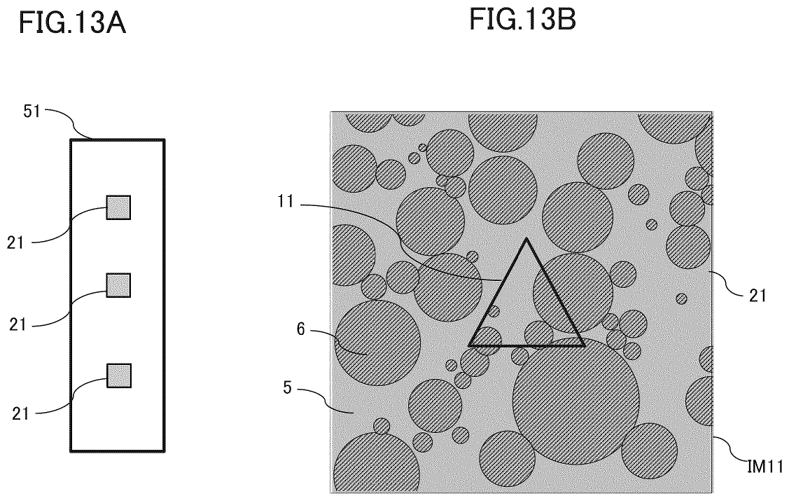

FIG. 13A is a schematic diagram of a small test piece 51 of the third embodiment. FIG. 13B is a schematic diagram of the image IM11 obtained by capturing an image of an image capture range 21 of the small test piece 51 of the third embodiment. The small test piece 51 is a test piece that has an area of 1 mm×0.3 mm, and a thickness of 50 μm.

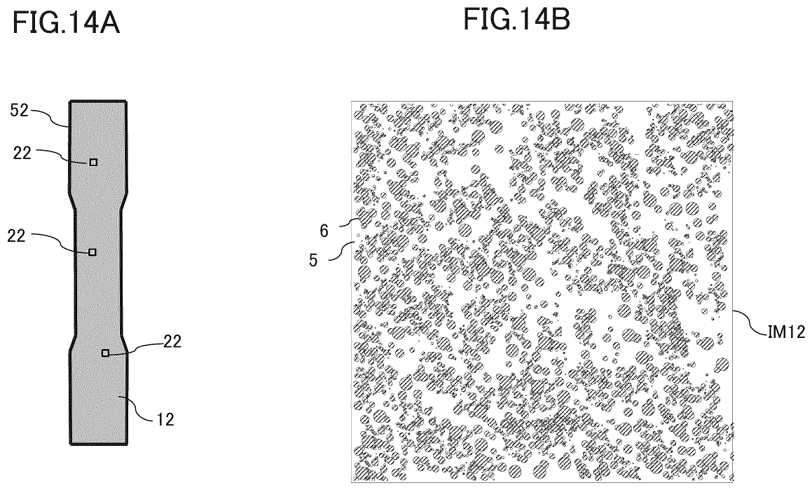

FIG. 14A is a schematic diagram of a standard test piece 52 of the third embodiment. The standard test piece 52 is a dumbbell test piece that conforms to JIS Z 2241 provided in Japanese Industrial Standards, and that has a thickness of 3 mm. FIG. 14B is a schematic diagram of the image IM12 obtained by capturing an image of an image capture range 22 of the standard test piece 52 of the third embodiment.

As in the first embodiment, the image IM11 illustrated in FIG. 13B is an image of any one of a plurality of image capture ranges 21 of the small test piece 51 illustrated in FIG. 13A, captured with a magnification of 500 that is a first magnification, by using a microscope that is one example of the image capture apparatus 200. As also in the first embodiment, the image IM12 illustrated in FIG. 14B is an image of any one of a plurality of (e.g., three) image capture ranges 22 of the standard test piece 52 illustrated in FIG. 14A, captured with a magnification of 50 that is a second magnification lower than the first magnification, by using an optical microscope that is one example of the image capture apparatus 250.

In a range 11 of the small test piece 51 related to the image IM11 obtained by capturing an image of the image capture range 21, the physical-property values P11 and P14 whose types are different from each other are measured by using the measuring apparatus 500. In the third embodiment, as the physical-property value P11 of the range 11 of the small test piece 51, a value of a mechanical property of the range 11 of the small test piece 51, such as a value of Young's modulus of the range 11, is obtained. In addition, as the physical-property value P14 of the second physical property of the range 11 of the small test piece 51, a value of a mechanical property of the range 11 of the small test piece 51, such as a value of hardness of the range 11, is obtained. That is, as an example, the first physical property is Young's modulus, and the second physical property is hardness.

The physical-property values P11 and P14 are obtained by measuring the range 11 by using a nanoindenter as the measuring apparatus 500. Specifically, the indentation test of Berkovich indenter is performed by using the nanoindenter, and thereby a relationship between the load and the amount of indentation is obtained. The result is analyzed by using Oliver-Pharr method, and thereby a value of Young's modulus is obtained as the physical-property value P11, and a value of hardness is obtained as the physical-property value P14. The range 11 is substantially the size of indentation. Note that although the description has been made for the case where the physical-property value P14 is obtained by using the measuring apparatus 500 used for obtaining the physical-property value P11, the present disclosure is not limited to this. For example, the physical-property value P14 may be obtained by using an apparatus different from the measuring apparatus 500.

In the third embodiment, the physical-property value P12, which is the correct answer data A1 of the learning data T1, is obtained by using the measuring apparatus 550 different from the measuring apparatus 500. The physical-property value P12 is obtained by measuring a range 12 of the standard test piece 52 by using the measuring apparatus 550. The range 12 is a range larger than the range 11. In the present embodiment, the physical-property value P12 is a value of Young's modulus of the range 12 of the standard test piece 52.

The measuring apparatus 550 is a tensile tester, for example. The Young's modulus that serves as the first physical property is measured, conforming to JIS Z 2241 provided in Japanese Industrial Standards, from the load and the extension of the standard test piece 52, by pulling both ends of the standard test piece 52. The range 12 of the standard test piece 52 is the whole of the standard test piece 52.

In the learning phase, the images IM11 and IM12 and the physical-property values P11, P14, and P12 are obtained from a plurality of small test pieces 51 and a plurality of standard test pieces 52, which have different compositions of a material, the different amounts of mixed filler, and different processes for producing the material that involve a mixing condition and a heat-treatment condition. Thus, a plurality of data sets S1 is created, and constitutes the learning data T1. In this case, each of the plurality of data sets S1 includes the image IM11, the physical-property values P11 and P14, and the image IM12, as the input data IN1; and includes the physical-property value P12, as the correct answer data A1. The machine learning is performed by using the same method as that for the first embodiment and using the plurality of data sets S1 as input data, so that the machine-learning model M1 is created.

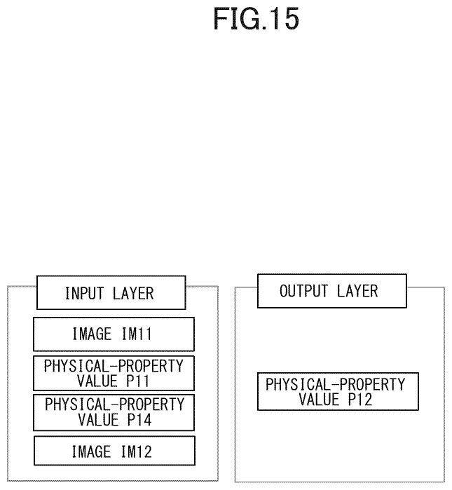

FIG. 15 is a diagram illustrating the machine learning performed in the third embodiment. FIG. 15 illustrates an input layer and an output layer of a regression model that uses the CNN. The input layer includes three images IM11, three physical-property values P11, three physical-property values P14, and three images IM12. The learning portion 1 performs the machine learning so that a single physical-property value P12 is output via a plurality of intermediate layers, so that the learned machine-learning model M1 that is an estimation model is created.

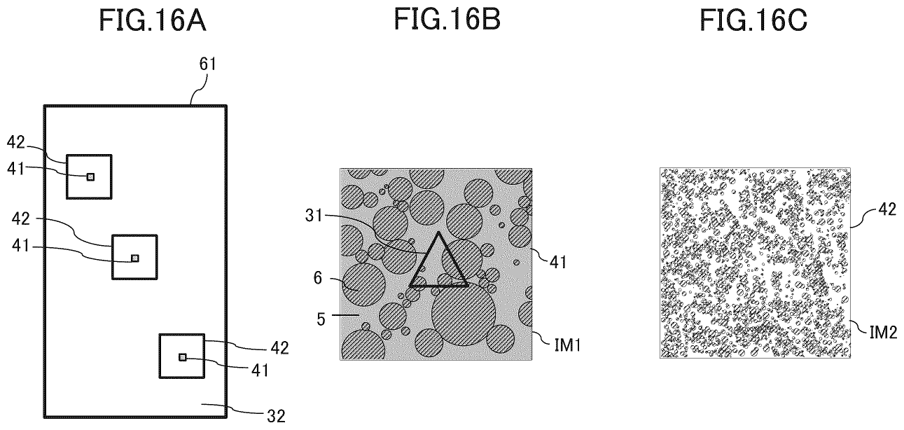

Next, the inference phase will be described. FIG. 16A is a schematic diagram of a sample 61 of the third embodiment. FIG. 16B is a schematic diagram of an image IM1 obtained by capturing an image of an image capture range 41 of the sample 61 of the third embodiment. FIG. 16C is a schematic diagram of an image IM2 obtained by capturing an image of an image capture range 42 of the sample 61 of the third embodiment.

The image capture range 41 is one example of a first image-capture range. The image IM1 is one example of a first image. As in the first embodiment, the image of the image capture range 41 is captured by using the image capture apparatus 200, with a magnification equal to that of the first embodiment. The image capture range 42 is one example of a second image-capture range. The image IM2 is one example of a second image. As in the first embodiment, the image of the image capture range 42 is captured by using the image capture apparatus 250, with a magnification equal to that of the first embodiment.

Then, in a range 31 of the sample 61 related to the image IM1 obtained by capturing an image of the image capture range 41, the physical-property value P1 of the first physical property and the physical-property value P4 of the second physical property are obtained. The range 31 is one example of a first range. In the third embodiment, the first physical property is Young's modulus, and the physical-property value P1 is a value that indicates Young's modulus. In addition, in the third embodiment, the second physical property is hardness, and the physical-property value P4 is a value that indicates hardness. Both of Young's modulus and hardness are one example of the mechanical property. The value of each of Young's modulus and hardness is obtained by measuring the range 31 by using a nanoindenter.

The estimation portion 2 estimates the physical-property value P2 of the first physical property of the range 32 of the sample 61 larger than the range 31, by using at least the image IM1, the physical-property value P1, the physical-property value P4, and the image IM2. The range 32 is one example of a second range.

In the third embodiment, the physical-property value P2 of the first physical property of the range 32 is estimated by the estimation portion 2 in the inference process. That is, the estimation portion 2 uses the learned machine-learning model M1 that uses the image IM1, the physical-property value P1, the physical-property value P4, and the image IM2 as the input data IN2 for estimating the physical-property value P2, and that outputs the physical-property value P2 as the output data OUT2. In the present embodiment, the first physical property of the range 32 is Young's modulus of the sample 61.

In the inference phase, the images IM1 and IM2, and the physical-property values P1 and P4 are included in the input data IN2, and the physical-property value P2 is output as the output data OUT2. Thus, in the third embodiment, the need for making the sample 61 in the inference phase, conforming to Japanese Industrial Standards, can be eliminated, so that the cost and time for making the sample 61 can be reduced. In addition, since the number of physical-property values used for the estimation is increased, the accuracy for estimating the physical-property value P2 increases.

### Fourth Embodiment

Next, a fourth embodiment will be described. Hereinafter, a component given the same reference symbol as that of a component of the above-described various embodiments has substantially the same structure and effects as those of the component of the first embodiment, unless otherwise specified; and thus, features different from those of the first embodiment will be mainly described.

Since the hardware configuration of the physical-property estimation system of the fourth embodiment is substantially the same as the hardware configuration of the physical-property estimation system 1000 of the first embodiment illustrated in FIG. 1, the description of the hardware configuration of the physical-property estimation system of the fourth embodiment will be omitted. In the fourth embodiment, the CPU 101 estimates a second physical-property value that is in correlation with a first physical-property value. Note that physical-property values that are in correlation with each other are physical-property values, such as hardness and strength, that are related to each other by a physical factor. Since the hard material has stronger bonding of atoms and less deforms, the material tends to have higher strength because of being strong against the external force. Thus, it is considered that the hardness and the strength are related to each other by a physical factor.

Also in the fourth embodiment, the CPU 101 illustrated in FIG. 1 functions as the learning portion 1 and the estimation portion 2 illustrated in FIG. 2A, by executing the program 161. Specifically, the CPU 101 functions as the learning portion 1 in the learning phase, and as the estimation portion 2 in the inference phase. The learning portion 1 executes a learning method, and the estimation portion 2 executes a physical-property estimation method. In addition, an object on which the inference is performed is expressed as a sample, and an object which is used for obtaining the learning data is expressed as a test piece. For example, the sample is a prototype.

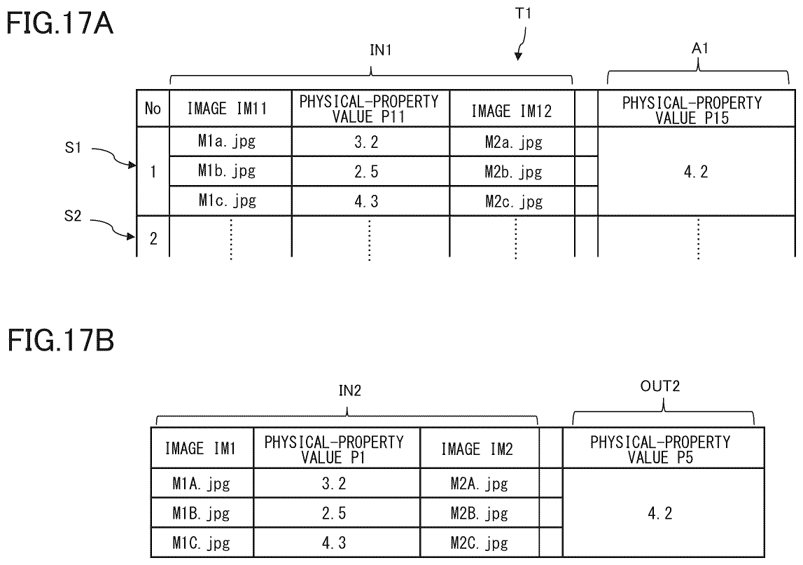

FIG. 17A is a diagram illustrating one example of learning data T1 of the fourth embodiment. FIG. 17B is a diagram illustrating one example of input data IN2 that is used for the inference in the fourth embodiment, and of output data OUT2 that is an inference result.

The learning portion 1 performs the supervised learning in the learning phase, as the machine learning. The learning portion 1 performs the supervised machine learning by using the learning data T1, and creates the learned machine-learning model M1 illustrated in FIG. 2A. The learning data T1 includes a plurality of data sets S1, each of which includes input data IN1 and correct answer data A1. The machine-learning model M1 is stored, for example, in the SSD 104 illustrated in FIG. 1. The estimation portion 2 performs the inference on the input data IN2 in the inference phase, by using the learned machine-learning model M1; and outputs the output data OUT2 that is an inference result.

In the learning phase, the learning portion 1 takes in an image IM11, a physical-property value P11, and an image IM12; and creates the machine-learning model M1 by using a physical-property value P15, as the correct answer data A1, that is in correlation with the physical-property value P11. In the inference phase, the estimation portion 2 uses, as the input data IN2, an image IM1, a physical-property value P1, and an image IM2; and estimates a physical-property value P5 by using the created machine-learning model M1.

Each of the plurality of data sets S1 includes, as the input data IN1, at least one image IM11 of a microscopic area of a test piece, at least one physical-property value P11 of a physical property of a microscopic area of the test piece, and at least one image IM12 of a macroscopic area of a test piece. In addition, each of the plurality of data sets S1 includes, as the correct answer data A1, the physical-property value P15 of a physical property of a macroscopic area of a test piece. The physical-property value P15 is in correlation with the physical-property value P11.

The image IM11 is digital data, such as a captured image, obtained by the image capture apparatus 200 capturing an image of a test piece with a first magnification. The image IM12 is digital data, such as a captured image, obtained by the image capture apparatus 250 capturing an image of a test piece with a second magnification lower than the first magnification. The image capture apparatus 200 captures an image of a test piece with a magnification higher than that of the image capture apparatus 250. Both of the image IM11 and the image IM12 are images captured with magnifications higher than 1.

The input data IN2 includes at least one image IM1 of a microscopic area of a sample, at least one physical-property value P1 of a physical property of a microscopic area of the sample, and at least one image IM2 of a macroscopic area of the sample. In addition, the output data OUT2 is the physical-property value P5 of the physical-property of the macroscopic area. The physical-property value P5 is in correlation with the physical-property value P1. The physical-property value P1 is one example of a first physical-property value. The physical-property value P5 is one example of a second physical-property value.

The image IM1 is digital data, such as a captured image, obtained by the image capture apparatus 200 capturing an image of the sample with a first magnification. The image IM2 is digital data, such as a captured image, obtained by the image capture apparatus 250 capturing an image of the sample with a second magnification. The image capture apparatus 200 captures an image of the sample with a magnification higher than that of the image capture apparatus 250. Both of the image IM1 and the image IM2 are images captured with magnifications higher than 1.

The number of the images IM1 is the same as the number of the images IM11 of a single data set S1. The number of the physical-property values P1 is the same as the number of the physical-property values P11 of a single data set S1. The number of the images IM2 is the same as the number of the images IM12 of a single data set S1.

A small test piece 51 of the fourth embodiment is the same as the small test piece 51 of the third embodiment illustrated in FIG. 13A, and the image IM11 illustrated in FIG. 13B is obtained by capturing an image of the image capture range 21. The detailed description of the small test piece 51 will be omitted. In addition, a standard test piece 52 of the fourth embodiment is also the same as the standard test piece 52 of the third embodiment illustrated in FIG. 14A, and the image IM12 illustrated in FIG. 14B is obtained by capturing an image of the image capture range 22. Since the small test piece 51, the standard test piece 52, the image IM11, and the image IM12 are the same as those described in the third embodiment, the detailed description thereof will be omitted. The fourth embodiment differs from the third embodiment in the physical property of the small test piece 51 and the physical property of a macroscopic area of the standard test piece 52.

In a range 11 of the small test piece 51 related to the image IM11 obtained by capturing an image of the image capture range 21, the physical-property value P11 of a physical property is obtained by using the measuring apparatus 500. In the fourth embodiment, as the physical-property value P11 of the range 11 of the small test piece 51, a value of a mechanical property of the range 11 of the small test piece 51, such as a value of Young's modulus of the range 11, is obtained.

The physical-property value P11 is obtained by measuring the range 11 by using a nanoindenter as the measuring apparatus 500. Specifically, the indentation test of Berkovich indenter is performed by using the nanoindenter, and thereby a relationship between the load and the amount of indentation is obtained. The result is analyzed by using Oliver-Pharr method, and thereby a value of Young's modulus is obtained. The range 11 is substantially the size of indentation.

In the fourth embodiment, the physical-property value P15, which is the correct answer data A1 of the learning data T1, is obtained by using the measuring apparatus 550 different from the measuring apparatus 500. The physical-property value P15 is obtained by measuring the range 12 of the standard test piece 52 illustrated in FIG. 14A, by using the measuring apparatus 550. The range 12 is a range larger than the range 11. In the present embodiment, the physical property that corresponds to the physical-property value P15 is the tensile strength of the range 12 of the standard test piece 52. The measuring apparatus 550 is a tensile tester, for example. The physical-property value P15 of the range 12 of the standard test piece 52 is obtained by pulling both ends of the standard test piece 52, conforming to JIS Z 2241 provided in Japanese Industrial Standards, and by measuring the tensile strength from the maximum load and a cross-sectional area of the standard test piece 52.

In the learning phase, the images IM11 and IM12 and the physical-property values P11 and P15 are obtained from a plurality of small test pieces 51 and a plurality of standard test pieces 52, which have different compositions of a material, the different amounts of mixed filler, and different processes for producing the material that involve a mixing condition and a heat-treatment condition. Thus, a plurality of data sets S1 is created, and constitutes the learning data T1. In this case, each of the plurality of data sets S1 includes the image IM11, the physical-property values P11, and the image IM12, as the input data IN1; and includes the physical-property value P15, as the correct answer data A1. The machine learning is performed by using the same method as that for the first embodiment and using the plurality of data sets S1 as input data, so that the machine-learning model M1 is created.

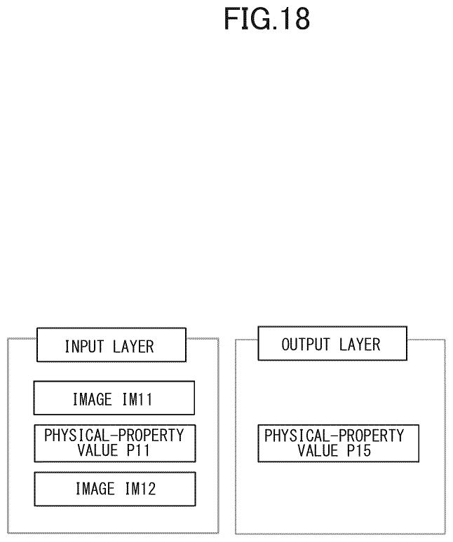

FIG. 18 is a diagram illustrating the machine learning performed in the fourth embodiment. FIG. 18 illustrates an input layer and an output layer of a regression model that uses the CNN. The input layer includes three images IM11, three physical-property values P11, and three images IM12. The learning portion 1 performs the machine learning so that a single physical-property value P15 is output via a plurality of intermediate layers, so that the learned machine-learning model M1 that is an estimation model is created.

Next, the inference phase will be described. Also in the inference phase of the fourth embodiment, the sample 61 illustrated in FIG. 16A is used. As a result, the image IM1 illustrated in FIG. 16B and obtained by capturing an image of the image capture range 41, and the image IM2 illustrated in FIG. 16C and obtained by capturing an image of the image capture range 42 are obtained. Since the sample 61 and the images IM1 and IM2 are the same as those described in the third embodiment, the detailed description thereof will be omitted. The fourth embodiment differs from the third embodiment in the physical property of a macroscopic area of the sample 61.

In the range 31 of the sample 61 related to the image IM1 obtained by capturing an image of the image capture range 41, the physical-property value P1 of a physical property is obtained. The range 31 is one example of a first range. In the fourth embodiment, as the physical-property value P1 of the range 31 of the sample 61, a value of a mechanical property of the range 31 of the sample 61, such as a value of Young's modulus of the range 31, is obtained.

Then, the estimation portion 2 estimates the physical-property value P5 of a physical property of the range 32 of the sample 61 larger than the range 31, by using at least the image IM1, the physical-property value P1, and the image IM2. The range 32 is one example of a second range.

In the fourth embodiment, the physical-property value P5 of the physical property of the range 32 is estimated by the estimation portion 2 in the inference process. That is, the estimation portion 2 uses the learned machine-learning model M1 that uses the image IM1, the physical-property value P1, and the image IM2 as the input data IN2 for estimating the physical-property value P5 of the physical property, and that outputs the physical-property value P5 of the physical property as the output data OUT2. In the present embodiment, the physical property that corresponds to the physical-property value P5 is the tensile strength of the range 32 of the sample 61.

In the inference phase, the images IM1 and IM2, and the physical-property values P1 are included in the input data IN2, and the physical-property value P5 is output as the output data OUT2. Thus, in the fourth embodiment, the need for making the sample 61 in the inference phase, conforming to Japanese Industrial Standards, can be eliminated, so that the cost and time for making the sample 61 can be reduced. In addition, one physical property related to another by a physical factor can also be estimated with high accuracy even though the one physical property is not the same as the other.

The present disclosure is not limited to the above-described embodiments, and the embodiments can be modified variously within the technical concept of the present disclosure. In addition, the effects described in the embodiments are merely most effective

effects produced by the present disclosure, and thus the effects of the present disclosure are not limited to those described in the embodiments.

In the above-described embodiments, the description has been made for the case where the estimation portion 2 preferably estimates the physical-property value P2 by using the learned machine-learning model M1. However, the method of estimating the physical-property value P2 is not limited to the machine learning. For example, the physical-property value P2 may be estimated by using a predetermined computation process.

As described above, the present disclosure provides a technology advantageous for increasing the accuracy for estimating the physical-property value of a sample.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-212269, filed Dec. 5, 2024, and Japanese Patent Application No. 2025-179582, filed Oct. 24, 2025, which are hereby incorporated by reference herein in their entirety.

What is claimed is:

1. A physical-property estimation apparatus comprising a processor configured:
to accept a first image obtained by capturing an image of a first image-capture range of a sample with a first magnification, a first physical-property value of a first range of the sample, and a second image obtained by capturing an image of a second image-capture range of the sample larger than the first image-capture range, with a second magnification lower than the first magnification; and
to estimate a second physical-property value of a second range of the sample larger than the first range, by using at least the first image, the first physical-property value, and the second image.

2. The physical-property estimation apparatus according to claim 1, wherein the first range is configured to overlap with the first image-capture range.

3. The physical-property estimation apparatus according to claim 2, wherein the first range is equal to or larger than the first image-capture range and equal to or smaller than the second image-capture range.

4. The physical-property estimation apparatus according to claim 2, wherein the first range is equal to or larger than 0.9 times the first image-capture range and equal to or smaller than 1.1 times the first image-capture range.

5. The physical-property estimation apparatus according to claim 1, wherein the first magnification is equal to or higher than 5 times the second magnification and equal to or lower than 20 times the second magnification.

6. The physical-property estimation apparatus according to claim 1, wherein the processor is configured to display the first image-capture range of the first image on a display apparatus such that the first image-capture range overlaps with the second image.

7. The physical-property estimation apparatus according to claim 1, wherein the processor is configured to use a learned machine-learning model that uses the first image, the first physical-property value, and the second image as input data for estimating the second physical-property value, and that outputs the second physical-property value as output data.

8. The physical-property estimation apparatus according to claim 1, wherein each of a physical property that corresponds to the first physical-property value and a physical property that corresponds to the second physical-property value is electrical property, thermal property, mechanical property, or optical property.

9. The physical-property estimation apparatus according to claim 1, wherein the processor is configured:
to accept a third image and a third physical-property value, the third image being an image obtained by capturing an image of a third image-capture range of the sample larger than the first image-capture range and smaller than the second image-capture range, with a third magnification between the first magnification and the second magnification, the third physical-property value being a value of a third range larger than the first range and smaller than the second range; and
to estimate the second physical-property value by using the first image, the first physical-property value, the second image, the third image, and the third physical-property value.

10. The physical-property estimation apparatus according to claim 1, wherein the processor is configured:
to accept a fourth physical-property value of the first range whose type is difficult from the first physical-property value; and
to estimate the second physical-property value by using at least the first image, the first physical-property value, the fourth physical-property value, and the second image.

11. The physical-property estimation apparatus according to claim 1, wherein the second physical-property value is in correlation with the first physical-property value.

12. A physical-property estimation system comprising:
the physical-property estimation apparatus according to claim 1;
a first image-capture apparatus configured to obtain the first image by capturing an image of the first image-capture range of the sample;
a second image-capture apparatus configured to obtain the second image by capturing an image of the second image-capture range of the sample; and
a measuring apparatus configured to obtain the first physical-property value by measuring a physical property of the first range of the sample.

13. A physical-property estimation system comprising:
the physical-property estimation apparatus according to claim 1;
an image capture apparatus configured to obtain the first image by capturing an image of the first image-capture range of the sample, and obtain the second image by capturing an image of the second image-capture range of the sample; and
a measuring apparatus configured to obtain the first physical-property value by measuring a physical property of the first range of the sample.

14. A physical-property estimation method performed by a processor, the method comprising:
accepting, by the processor, a first image obtained by capturing an image of a first image-capture range of a sample with a first magnification, a first physical-property value of a first range of the sample, and a second image obtained by capturing an image of a second image-capture range of the sample larger than the first image-capture range, with a second magnification lower than the first magnification; and
estimating, by the processor, a second physical-property value of a second range of the sample larger than the first range, based on the first image, the first physical-property value, and the second image.

15. The physical-property estimation method according to claim 14, wherein the first range overlaps with the first image-capture range.

16. The physical-property estimation method according to claim 15, wherein the first range is equal to or larger than the first image-capture range and equal to or smaller than the second image-capture range.

17. The physical-property estimation method according to claim 15, wherein the first range is equal to or larger than 0.9 times the first image-capture range and equal to or smaller than 1.1 times the first image-capture range.

18. The physical-property estimation method according to claim 14, wherein the first magnification is equal to or higher than 5 times the second magnification and equal to or lower than 20 times the second magnification.

19. The physical-property estimation method according to claim 14, wherein the processor displays the first image-capture range of the first image on a display apparatus such that the first image-capture range overlaps with the second image.

20. The physical-property estimation method according to claim 14, wherein the processor uses a learned machine-learning model that uses the first image, the first physical-property value, and the second image as input data for estimating the second physical-property value, and that outputs the second physical-property value as output data.

21. The physical-property estimation method according to claim 14, wherein each of a physical property that corresponds to the first physical-property value and a physical property that corresponds to the second physical-property value is electrical property, thermal property, mechanical property, or optical property.

22. The physical-property estimation method according to claim 14, the method comprising:
accepting, by the processor, a third image and a third physical-property value, the third image being an image obtained by capturing an image of a third image-capture range of the sample larger than the first image-capture range and smaller than the second image-capture range, with a third magnification between the first magnification and the second magnification, the third physical-property value being a value of a third range larger than the first range and smaller than the second range; and
estimating, by the processor, the second physical-property value by using the first image, the first physical-property value, the second image, the third image, and the third physical-property value.

23. The physical-property estimation method according to claim 14, the method comprising:
accepting, by the processor, a fourth physical-property value of the first range whose type is difficult from the first physical-property value; and
estimating, by the processor, the second physical-property value by using at least the first image, the first physical-property value, the fourth physical-property value, and the second image.

24. The physical-property estimation method according to claim 14, wherein the second physical-property value is in correlation with the first physical-property value.

25. A non-transitory computer-readable storage medium storing a program that causes a computer to execute the physical-property estimation method according to claim 14.
